(19) United States
(12) Patent Application Publication
(10) Pub. No.: US 2024/0370807 A1
(43) Pub. Date: Nov. 7, 2024

(54) APPARATUS AND METHODS FOR PROVIDING A SKILL FACTOR HIERARCHY TO A USER

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto (CA)

(21) Appl. No.: 18/623,435

(22) Filed: Apr. 1, 2024

Related U.S. Application Data
(63) Continuation-in-part of application No. 18/142,274, filed on May 2, 2023, now Pat. No. 12,001,991.

(51) Int. Cl. G06Q 10/0631; G06N 20/00

(52) U.S. Cl. CPC G06Q 10/0639; G06Q 10/063112; G06N 20/00

(57) ABSTRACT

An apparatus and method provide a skill factor hierarchy to a user. Apparatus may include a computing device including a processor and a memory connected to the processor. The processor may receive a commitment datum describing user activity to match a target and identify a novelty datum as a function of the commitment datum. The processor may identify a first skill factor datum as a function of the novelty datum. Refining the first skill factor datum may include classifying the novelty datum to the first skill factor datum and aggregating the first skill factor datum with a second skill factor datum based on the classification. The processor may generate an interface query data structure including an input field based on aggregations of the skill factor datum and configure a remote display device to at least display the first skill factor and at least the second skill factor datum hierarchically.

### CROSS-REFERENCE TO RELATED APPLICATIONS

This application is a continuation-in-part of Non-provisional application Ser. No. 18/142,274, filed on May 2, 2023, and entitled “APPARATUS AND METHODS FOR PROVIDING A SKILL FACTOR HIERARCHY TO A USER,” the entirety of which is incorporated herein by reference.

### FIELD OF THE INVENTION

The present invention generally relates to the field of skill identification and development related coaching for entrepreneurs and business managers. In particular, the present invention is directed to an apparatus and methods for providing a skill factor hierarchy to a user.

### BACKGROUND

Current data processing or digital resource management techniques tend to focus on high-level performance trends demonstrated by tracked phenomena, rather than intaking specific points of data corresponding to one or more traits related to efficiently achieving an enumerated target. Prior programmatic attempts to resolve these and other related issues have suffered from inadequate user-provided data intake and subsequent processing capabilities.

### SUMMARY OF THE DISCLOSURE

In an aspect, an apparatus for providing a customized skill factor datum to a user is provided. The apparatus includes at least a processor and a memory communicatively connected to the at least a processor, the memory containing instructions configuring the at least a processor to receive a commitment datum describing a pattern that is representative of user activity progressing to match a target, determine a target datum as a function of the commitment datum, identify a novelty datum as a function of the commitment datum and the target datum, wherein the novelty datum includes data related to management of resources, and wherein identifying the novelty datum includes classifying the novelty datum into one or more resource categories and generating efficiency data as a function of the one or more resource categories, generate a skill factor datum as a function of the novelty datum, determine at least an obstacle datum as a function of the target datum and the skill factor datum, generate a directed process as a function of the at least an obstacle datum, wherein the directed process includes a set of instructions to improve the efficiency data, and wherein generating the directed process includes generating process training data, wherein the process training data includes correlations between exemplary obstacle datums, exemplary efficiency data and exemplary directed processes, iteratively training a process machine-learning model using the process training data as a function of previous iterations and generating the directed process using the trained process machine-learning model and generate an interface query data structure, wherein the interface query data structure configures a display device to display the efficiency data and the directed process.

In another aspect, a method for providing a customized skill factor datum to a user is provided. The method includes receiving, using at least a processor, a commitment datum describing a pattern that is representative of user activity progressing to match a target, determining, using the at least a processor, a target datum as a function of the commitment datum, identifying, using the at least a processor, a novelty datum as a function of the commitment datum and the target datum, wherein the novelty datum includes data related to management of resources, and wherein identifying the novelty datum includes classifying the novelty datum into one or more resource categories and generating efficiency data as a function of the one or more resource categories, generating, using the at least a processor, a skill factor datum as a function of the novelty datum, determining, using the at least a processor, at least an obstacle datum as a function of the target datum and the skill factor datum, generating, using the at least a processor, a directed process as a function of the at least an obstacle datum, wherein the directed process comprises a set of instructions to improve the efficiency data, and wherein generating the directed process includes generating process training data, wherein the process training data comprises correlations between exemplary obstacle datums, exemplary efficiency data and exemplary directed processes, iteratively training a process machine-learning model using the process training data as a function of previous iterations and generating the directed process using the trained process machine-learning model; and generating, using the at least a processor, an interface query data structure, wherein the interface query data structure configures a display device to display the efficiency data and the directed process.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an embodiment of an apparatus for data processing relating to providing a personal performance data output;

FIGS. 2A-2B are diagrammatic representations of multiple exemplary embodiments of output generated by an interface query data structure;

FIG. 3 is a diagrammatic representation of a query database;

FIG. 4 is a block diagram of exemplary machine-learning processes;

FIG. 5 is a graph illustrating an exemplary relationship between fuzzy sets;

FIG. 6 is a flow diagram of an exemplary method for providing a customized skill factor datum to a user;

FIG. 7 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and methods for data processing relating to providing a customized skill factor datum to a user. Described processes are executed by a computing device including a processor, which is configured to execute any one or more of the described steps. A memory is connected to the processor and contains instructions configuring the processor to receive a commitment datum. Examples may include commitment towards regular practice sessions in an area of interest, such as learning a foreign language, martial art, or sport. Commitment data may include novelty assessed by monitored intervals, such as increasing progressive resistance (e.g., “weight”) training over time as evidenced by lifting heavier weights, completing more repetitions, or changing movements, etc.

In some embodiments, such commitment data may be input into the apparatus manually by a user associated with an establishment, such as a business, a fitness gym, a martial arts studio, a university, and/or any other type of entity. Such entry may be performed by, for example, touching interactive sections on a touch-sensitive smartphone or other digital peripheral or device to enter the commitment data. Alternatively, in some other embodiments, commitment data may be obtained by other means, such as being digitally extracted from a business or some other type of profile, which may include prior achievements of a user in various fields such as business, finance, and personal affairs, such as dating, relationships and/or the like. As an example, a business profile may include business records such as financial records, inventory record, sales records, and the like.

In addition, or as an alternative, a dating profile may include personal photos of vacations or participating in recreational activities or at events, as well as a textual description of lifestyle preferences a long-term target. Further, in some embodiments, commitment data may be generated by evaluating interactions of the user with one or more external entities. In the context of a business, this evaluation may include extracting and processing data describing creditworthiness, including examining long-term and short-term spending patterns and repayment histories commensurate with those patterns. In the context of physical fitness, this evaluation may include observing gym attendance rates, caloric burn data, and weight training completion.

Alternatively, in other embodiments, the commitment datum may be extracted from a database including data describing various attributes of the user. In addition, in some embodiments, receiving the commitment datum extracted from the database includes using scripts, any one or more of which are configured to track data describing one or more activities of the user on the Internet. Also, receiving the commitment datum extracted from the database includes using data scrapers, which may be scrapers programmed to gather data describing the user from social media resources on the Internet.

In addition, in some embodiments, the memory configures the processor to identify a novelty datum as a function of the commitment datum using a machine-learning model including a classifier. As used herein, a “novelty datum” is any type of datum or data describing conception of a novel method, idea, product, and/or the like, as well as identification, incorporation and/or usage of tools, activities, educational workshops and other items or services that assisted the user achieve performance improvements related to attaining the enumerated target within the defined duration. In a business operational context, in some embodiments, the novelty datum may describe various internal changes within the organization. Such internal changes may include increased organizational structure, offering different services or products, a change in the existing services or products, management of resources, and the like.

Identification of the novelty datum may include using a machine-learning model to analyze the commitment datum by evaluating, as described by the commitment datum, a pattern of activity leading up to the user achievement of a target. Accordingly, processor may identify the novelty data from the pattern of activity that led to the achievement of a target.

The novelty datum describes indicators categorized into multiple categories. More particularly, each category relates to data describing a skill used by the user for matching the target as indicated by the novelty datum. The classifier correlates at least an element describing the pattern of the commitment datum to the target and generates a skill factor datum, which may include data describing obstacle traversal by the user. Also, in some instances, the classifier of the machine-learning model may classify at least the element describing the pattern of the commitment datum to matching the target between a minimum value and a maximum value. In some instances, the novelty datum includes data describing one or more activities completed by the user relating to the user matching the target and/or data describing changes in resource sharing for assisting the user match the target.

As used herein, commitment datum is a part of “commitment data,” defined as any data related to recent (e.g., within a defined duration, such as 3 consecutive months, 6 consecutive months, etc.) activity related to attaining an achievement-related target, or improvements in novelty made by the user. Alternatively put, commitment datum describes a pattern that is representative of user activity or user activity progressing to match a target. That is, “commitment,” as generally understood as the state or quality of being dedicated to a cause, activity, etc., can be represented by a datum, or data tracking or monitoring particular aspects of user behavior. In the context of fiscal responsibility for a bank, demonstration of “commitment,” as used herein, is performing sufficient due diligence to accurately ascertain a potential customer's capability to routinely and timely repay outstanding loan obligations within a reasonable (e.g., market-standard, such as a 30-year loan term for a conventional residential mortgage product) term. Likewise, “commitment” may be demonstrated in other contexts as well, such as in the field of martial arts, where committed students may progress from one color rank belt to the next to ultimately reach one or more degrees of black belt status, depending on skill, speed, endurance, and other measurement variables. Consequently, commitment datum describes such repeat behavior demonstrating commitment toward reaching such an enumerated goal, such as a certain volume of work-product output, educational attainment, debt reduction, etc.

As used herein, a “skill factor datum” (e.g., skill factor datum) is a datum or data describing the ability to use one's knowledge effectively and readily in execution or performance, dexterity, or coordination especially in the execution of learned physical tasks, or a learned power of doing something competently, such as a developed aptitude or ability. For example, skill factor datum may describe certain skills in investment banking related careers, including intellect, discipline, creativity, open-mindedness, and/or relationship-building skills. Within these identified skills, there may be sub-skills, or skillsets, also capable of being identified and/or otherwise represented by skill factor datum.

In addition, skill factor datum, in one or more embodiments, may describe the “4Cs” for business, which, as used herein, are customers, costs, convenience and communication. That is, more particularly, skill factor datum, in the context of “customers,” may describe customers in the context of the worth of their respective desired products or services, any relevant competitive advantages provided by some sellers, and the market positioning of those sellers. In addition, skill factor datum may describe target customers, as well as potentially more than one target customer group, as well as the target customer's respective needs and desires, as well as market perception.

Further, skill factor datum, in the context of “costs,” may describe considerations including affordability, satisfaction and value of goods and services sold by a given entity, such as a business, from a consumer's point of view, while also considering profitability. That is, skill in the context of cost can include considerations of how cost-efficiently goods and services are provided to consumers in a competitive marketplace. Skill may also include considerations of strategically addressing local, state, and federal tax implications.

In addition, skill factor datum, in the context of “communication,” may describe how a given entity, such as a business, adeptly interacts, engages, or otherwise communicates with its respective customer base. Accordingly, skill factor datum, in this context, may describe information relating to customer benefits and social media usage rates for the deliberate development of products and services that customers are more likely to purchase.

Still further, skill factor datum, in the context of “convenience,” may describe how a given entity, such as a business, adeptly navigates and traverses various purchasing barriers, such as by leveraging online sales and providing products through multiple outlet types.

More particularly, within the skill of “intellect,” skill factor datum may capture, indicate and/or otherwise represent capabilities of a candidate relating to achievements in data analytics, mathematics, finance, economics, as well as skills outside of these core competencies, such as intellectual curiosity. For example, intellectual curiosity may be assessed and represented by skill factor datum by observing candidate behavior regarding reading books related to the profession outside of working hours. Data regarding candidate reading behavior during their personal time may be captured by requesting the candidate to input data into display device relating to reading behavior and comprehension, as evidenced by successfully answering or completing various forms of text and/or visual imagery-based quizzes or exams. In addition, in one or more embodiments, the skill factor datum may be used with novelty datum and include an identification of the skill. In addition, in some embodiments, the skill factor datum may additionally be an evaluation of the improvement and/or acquisition of the skill that facilitated the user traversing an obstacle toward reaching the target. Alternatively, in some other embodiments, the skill factor datum may also describe data relating to the user progressing toward achieving the target as indicated by, for example, at least the novelty datum.

In some embodiments, a skill factor may include a “skill improvement datum,” which is datum or data relating to providing the user with tips, exercises, and instructions on how to improve a skill factor. In addition, once a skill improvement datum is implemented by the user, the commitment datum may be iteratively revaluated. That is, for example, should the user input a target of running a mile within 7 minutes, described processes may evaluate the commitment of the user in attaining this target as shown by runs completed during the week, each run at varying intensity and/or speed. Should the user demonstrate marked improvement, such as by decreasing a total elapsed time to complete the run from 9 minutes to 7 minutes over the course of 3 months, described processes may recommend a faster pace, such as a 6:15 total elapsed mile run time. Conversely, should the user fail to demonstrate expected improvement, such as by either not decreasing the elapsed time overall or by decreasing elapsed time by an insignificant amount, then described processes may recommend a more gradual training program. In addition, such performance monitoring may also be considered to evaluate altering or iteratively updating one or more instances of the novelty datum, such as recommending a change in gait for the runner, in the context of the described running example.

In addition, in one or more embodiments, generating a skill factor as a function of the novelty datum may include assessing a category of each skill the user used to achieve the improvement as indicated by the novelty datum. The skill factor may be classified to the novelty datum using a classifier of a machine-learning model. Further, the skill factor may be aggregated based on classification to produce more accurate results, e.g., to output a customized skill factor for the user to attain the target. For example, when two or more skill factors are classified to a novelty datum, the entirety or a sub-set of these skill factors may be displayed to the user based on classification. That is, returning to the described example of the runner, skill factors such as calf strength gained by running uphill, neutral pronation, and/or steady breathing, etc., may be aggregated based on conceptual relation to each other. For example, both calf strength and neutral pronation relate to the legs and feet, whereas breathing techniques relate more to the respiratory system. As a result, skill factors relating to calf strength and neutral pronation may be aggregated under a general category or indicator of “leg training,” etc.

In addition, in one or more embodiments, the memory configures the processor to refine the skill factor datum as a function of the novelty datum. The skill factor datum is classified by the classifier to the novelty datum and aggregated with additional instances of the skill factor datum based on classification. Any one or more instances of the skill factor datum includes descriptions relating to acquisition of the skill, and descriptions of a frequency of implementation of the skill by the user correlated to the target. In addition, the memory configures the processor to generate an “interface query data structure” including an input field based on aggregations of the skill factor datum. An “interface query data structure,” as used in this disclosure, is an example of data structure used to “query,” such as by digitally requesting, for data results from a database and/or for action on the data. “Data structure,” in the field of computer science, is a data organization, management, and storage format that is usually chosen for efficient access to data. More particularly, a “data structure” is a collection of data values, the relationships among them, and the functions or operations that can be applied to the data. Data structures also provide a means to manage relatively large amounts of data efficiently for uses such as large databases and internet indexing services. Generally, efficient data structures are essential to designing efficient algorithms. Some formal design methods and programming languages emphasize data structures, rather than algorithms, as an essential organizing factor in software design. In addition, data structures can be used to organize the storage and retrieval of information stored in, for example, both main memory and secondary memory.

Therefore, “interface query data structure,” as used herein, refers to, for example, a data organization format used to digitally request a data result or action on the data. In addition, the “interface query data structure” can be displayed on a display device, such as a digital peripheral, smartphone, or other similar device, etc. The interface query data structure may be generated based on received “user data,” defined as including historical data of the user. Historical data may include attributes and facts about a user that are already publicly known or otherwise available, such as quarterly earnings for publicly traded businesses, etc. In some embodiments, interface query data structure prompts may be generated by a machine-learning model. As a non-limiting example, the machine-learning model may receive user data and output interface query data structure questions. Accordingly, the interface query data structure configures a remote display device to display the input field to the user and receive at least a user-input datum into the input field. The user-input datum includes data for selecting a preferred attribute of any one or more skills associated with one or more instances of the skill factor datum. In addition, in some instances, the user-input datum may be evaluated by using a classifier for classifying the user-input datum with at least some instances of the skill factor datum.

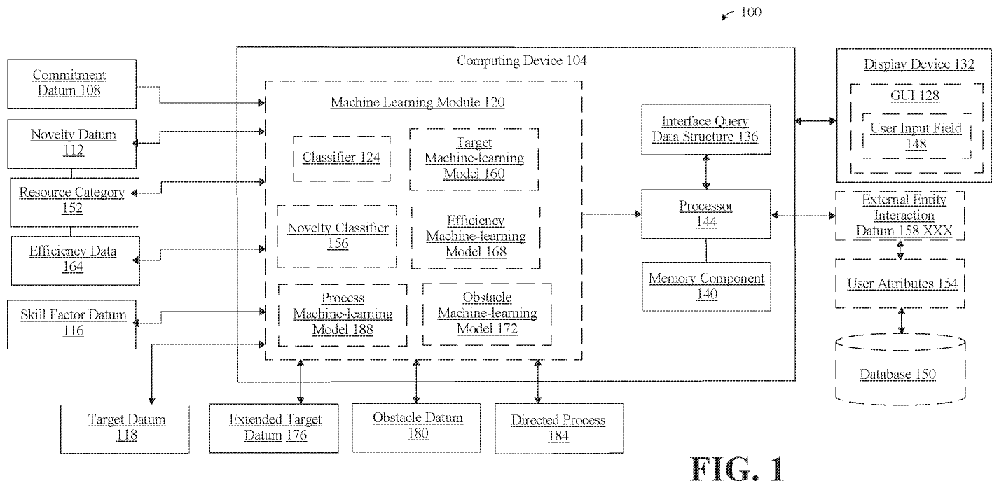

Referring now to FIG. 1, an exemplary embodiment of apparatus 100 for providing a customized skill factor datum to a user. In one or more embodiments, apparatus 100 includes computing device 104, which may include without limitation a microcontroller, microprocessor (also referred to in this disclosure as a “processor”), digital signal processor (DSP) and/or system on a chip (SoC) as described in this disclosure. Computing device 104 may include a computer system with one or more processors (e.g., CPUs), a graphics processing unit (GPU), or any combination thereof. Computing device 104 may include a memory component, such as memory component 140, which may include a memory, such as a main memory and/or a static memory, as discussed further in this disclosure below. Computing device 104 may include a display component (e.g., display device, which may be positioned remotely relative to computing device 104), as discussed further below in the disclosure. In one or more embodiments, computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices, as described below in further detail, via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, any combination thereof, and the like. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks, as described below, across a plurality of computing devices of computing device 104, which may operate in parallel, in series, redundantly, or in any other manner used for distribution of tasks or memory between computing devices. Computing device 104 may be implemented using a “shared nothing” architecture in which data is cached at the worker, in an embodiment, this may enable scalability of apparatus 100 and/or computing device 104.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 is configured to receive at least an element of commitment datum 108, which may include data describing current preferences relating to achieving a target by the user. For the purpose of this disclosure, a “commitment datum” is an element, datum, or elements of data describing historical data of performance of a user, such as any data related to achievements and/or improvements made by the user relating to attaining defined goal, identified by target datum 118 (to be explained in further detail below). As a non-limiting example, commitment datum 108 may include information related to activities, time, people, money or assets, incidences, education, or the like that a user has performed, used, experienced, consumed, or the like. In some embodiments, commitment datum 108 may be input into computing device 104 manually by the user, who may be associated with any type or form of establishment (e.g., a business, university, non-profit, charity, etc.), or may be an independent entity (e.g., a solo proprietor, an athlete, an artist, etc.). In some instances, commitment datum 108 may be extracted from a business profile, such as that may be available via the Internet on LinkedIn®, a business and employment-focused social media platform that works through websites and mobile apps owned my Microsoft® Corp., of Redmond, WA). More particularly, such a business profile may include the past achievements of a user in various fields such as business, finance, and personal, depending on one or more particular related circumstances. Persons skilled in the art, upon reviewing the entirety of this disclosure, will be aware of various other ways or situations in which commitment datum 108 may be input, generated, or extracted for various situations and goals. For example, in an example where the user is a business, commitment datum 108 may be extracted from or otherwise be based on the user's business profile, which may include various business records such as financial records, inventory record, sales records, and the like. In addition, in one or more embodiments, commitment datum 108 may be generated by evaluating interactions with external entities, such as third parties. More particularly, in a business-related context, such an example external entity (or third party) may be that offered by Moody's Investors Services, Inc., Moody's Analytics, Inc. and/or their respective affiliates and licensors, of New York, NY. Services rendered may include providing international financial research on bonds issued by commercial and government entities, including ranking the creditworthiness of borrowers using a standardized ratings scale which measures expected investor loss in the event of default. In such an example, commitment datum 108 extracted from such an external entity may include ratings for debt securities in several bond market segments, including government, municipal and corporate bonds, as well as various managed investments such as money market funds and fixed-income funds and financial institutions including banks and non-bank finance companies and asset classes in structured finance. In addition, or the alternative, in one or more embodiments, commitment datum 108 may be acquired using web trackers or data scrapers. As used herein, “web trackers” are scripts (e.g., programs or sequences of instructions that are interpreted or carried out by another program rather than by a computer) on websites designed to derive data points about user preferences and identify. In some embodiments, such web trackers may track activity of the user on the Internet. Also, as used herein, “data scrapers” are computer programs that extract data from human-readable output coming from another program. For example, data scrapers may be programmed to gather data on user from user's social media profiles, personal websites, and the like. In some embodiments, commitment datum 108 may be numerically quantified (e.g., by data describing discrete real integer values, such as 1, 2, 3 . . . n, where n=a user-defined or prior programmed maximum value entry, such as 10, where lower values denote lesser significance relating to favorable business operation and higher values denote greater significance relating to favorable business operation). For example, for classifying at least an element describing a pattern of commitment datum 108 (e.g., of a business) to target datum 118 in the context of fiscal integrity in financial services and retirement planning, commitment datum 108 may equal “3” for a business, such as an investment bank stock or mutual fund share, etc., suffering from credit liquidity problems stemming from a rapidly deteriorating macroeconomic environment and/or poor quality senior management, a “5” for only matching industry peers, and an “8” for significantly outperforming industry peers, etc.

With continued reference to FIG. 1, other example values are possible along with other exemplary attributes and facts about an entity that are already known and may be tailored to a particular situation where explicit business guidance (e.g., provided by the described progression sequence) is sought. In one or more alternative embodiments, commitment datum 108 may be described by data organized in or represented by lattices, grids, vectors, etc. and may be adjusted or selected as necessary to accommodate particular entity-defined circumstances or any other format or structure for use as a calculative value that a person skilled in the art would recognize as suitable upon review of the entirety of this disclosure.

With continued reference to FIG. 1, in one or more embodiments, commitment datum 108 may be provided to or received by computing device 104 using various means. In one or more embodiments, commitment datum 108 may be provided to computing device 104 by a business, such as by a human authorized to act on behalf of the business including any type of executive officer, an authorized data entry specialist or other type of related professional, or other authorized person or digital entity (e.g., software package communicatively coupled with a database storing relevant information) that is interested in improving and/or optimizing performance of the business overall, or in a particular area or field over a defined duration, such as a quarter or six months. In some examples, a human may manually enter commitment datum 108 into computing device 104 using, for example, user input field 148 of graphical user interface (GUI) 128 of display device 132. In a non-limiting example, GUI 128 may include interface query data structure 136. For example, and without limitation, a human may use display device 132 to navigate the GUI 128 and provide commitment datum 108 to computing device 104. Non-limiting exemplary input devices include keyboards, joy sticks, light pens, tracker balls, scanners, tablet, microphones, mouses, switches, buttons, sliders, touchscreens, and the like. In other embodiments, commitment datum 108 may be provided to computing device 104 by a database over a network from, for example, a network-based platform. Commitment datum 108 may be stored, in one or more embodiments, in database 150 and communicated to computing device 104 upon a retrieval request from a human and/or other digital device (not shown in FIG. 1) communicatively connected with computing device 104. In other embodiments, commitment datum 108 may be communicated from a third-party application, such as from a third-party application on a third-party server, using a network. For example, commitment datum 108 may be downloaded from a hosting website for a particular area, such as a networking group for small business owners in a certain city, or for a planning group for developing new products to meet changing client expectations, or for performance improvement relating to increasing business throughput volume and profit margins for any type of business, ranging from smaller start-ups to larger organizations that are functioning enterprises. In one or more embodiments, computing device 104 may extract commitment datum 108 from an accumulation of information provided by database 150. For instance, and without limitation, computing device 104 may extract needed information database 150 regarding improvement in a particular area sought-after by the business and avoid taking any information determined to be unnecessary. This may be performed by computing device 104 using a machine-learning model, which is described in this disclosure further below.

With continued reference to FIG. 1, at a high level, “a machine-learning” describes a field of inquiry devoted to understanding and building methods that “learn”—that is, methods that leverage data to improve performance on some set of defined tasks. Machine-learning algorithms may build a machine-learning model based on sample data, known as “training data”, to make predictions or decisions without being explicitly programmed to do so. Such algorithms may function by making data-driven predictions or decisions by building a mathematical model from input data. These input data used to build the machine-learning model may be divided in multiple data sets. In one or more embodiments, three data sets may be used in different stages of the creation of the machine-learning model: training, validation, and test sets.

With continued reference to FIG. 1, described machine-learning models may be initially fit on a training data set, which is a set of examples used to fit parameters. Here, example training data sets suitable for preparing and/or training described machine-learning processes may include data relating to historic business operations under historic circumstances, or circumstances in certain enumerated scenarios, such as during a period low interest rates or relatively easy bank lending, or during a period of highly restrictive fiscal policy implemented to control and address undesirably high inflation. Such training sets may be correlated to similar training sets of user attributes 154 relating to particular attributes of the user. In the described example of a business, such as a retail, regional, or even investment banks, user attributes may include data describing liquidity available to customers and performance of outstanding loans and other products. In addition, commitment datum 108 may include data describing a pattern of activity or conduct undertaken by the user regarding improvement of their performance. In banking, that may mean reducing risk exposure in relatively difficult macroeconomic conditions as dictated by higher-than-average federal interest rates, etc.

With continued reference to FIG. 1, in addition, in one or more embodiments, processor 144 is configured to determine or identify novelty datum 112. In a non-limiting example, novelty datum 112 may include an element, datum, or elements of data describing any activity, process, tool, equipment, etc., that assisted the user in progressing toward achieving target datum 118. As a non-limiting example, such activities may include implementing additional organizational structure, offering different services or products reflective of ongoing changes in customer preferences, or other changes in existing services or products, management of resources, and the like. In some embodiments, novelty datum 112 may include a pattern or data related to management of resources. As a non-limiting example, resources disclosed herein may include time, money, human resource, intellectual resource, physical resource, relationship, or the like. More particularly, in some instances, the “novelty datum” may be alternatively referred to as an “innovation datum” and thereby also be based on data describing practical implementation of ideas that result in the introduction of new goods or services or improvement in offering goods or services. Identification of novelty datum 112 may use a machine-learning model to analyze, for example, a pattern demonstrated by the user regarding achieving target datum 118, as also indicated by commitment datum 108. Alternatively put, commitment datum 108 may indicate a pattern of activity that leads up to the user's achievement of target datum 118. Accordingly, processor 144 may identify novelty datum 112 from data describing any pattern of activity that led to the user's achievement of target datum 118.

With continued reference to FIG. 1, processor 144 is configured to classify novelty datum 112 into one or more resource categories 152. For the purposes of this disclosure, a “resource category” is a collection of data points representing at least one attribute or characteristic of novelty datum. In some embodiments, each resource category 152 may include a distinct attribute, characteristic or theme of novelty datum 112. In a non-limiting example, first resource category may include novelty datum 112 related to human resource management, second resource category may include novelty datum 112 related to financial resource management, third resource category may include novelty datum 112 related to time management, or the like. In some embodiments, resource category 152 may be stored in database 150 and processor 144 may retrieve resource category 152 from database 150. In some embodiments, user may manually classify novelty datum 112.

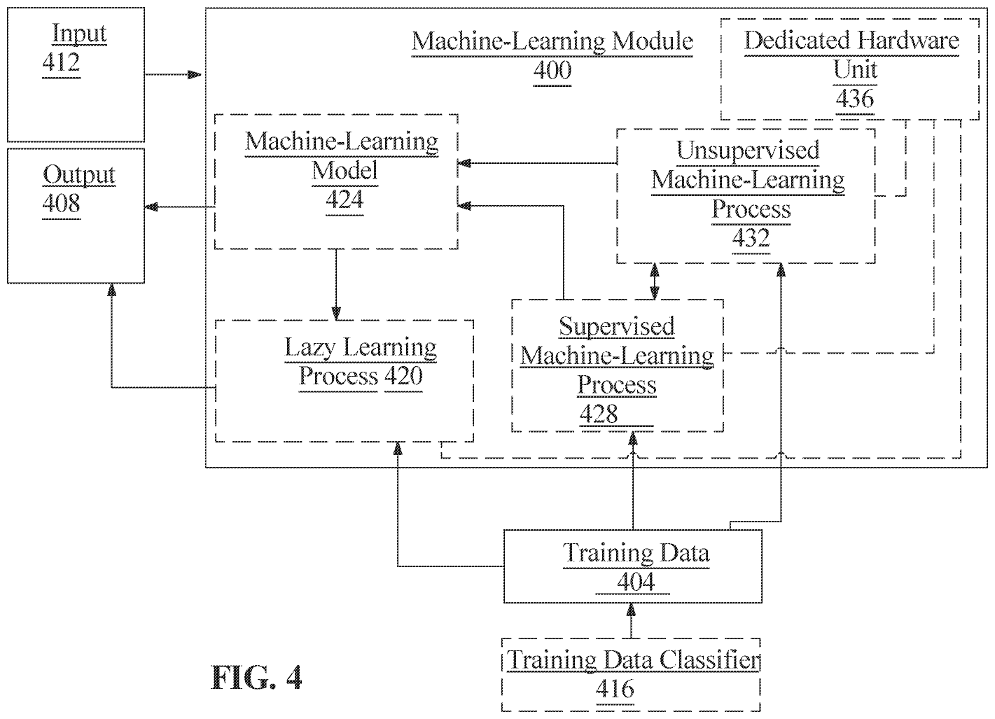

With continued reference to FIG. 1, in some embodiments, processor 144 may be configured to classify novelty datum 112 into one or more resource categories 152 using a novelty classifier 156. For the purposes of this disclosure, a “novelty classifier” is a machine-learning model, such as a mathematical model, neural net, or program generated by a machine-learning algorithm known as a “classification algorithm,” that sorts novelty datum related inputs into categories or bins of data, outputting one or more resource categories associated therewith. In some embodiments, novelty classifier 156 may include a feature extraction algorithm configured to extract or identify feature, characteristic or theme of novelty datum 112 and processor 144 may classify novelty datum 112 into one or more resource categories 152 using novelty classifier and extracted or identified feature. In some embodiments, processor 144 may be configured to generate novelty classification training data. In a non-limiting example, novelty classification training data may include correlations between exemplary novelty datums and exemplary resource categories. In some embodiments, novelty classification training data may be stored in database 150. In some embodiments, novelty classification training data may be received from one or more users, database 150, external computing devices, and/or previous iterations of processing. As a non-limiting example, novelty classification training data may include instructions from a user, who may be an expert user, a past user in embodiments disclosed herein, or the like, which may be stored in memory and/or stored in database 150, where the instructions may include labeling of training examples. In some embodiments, novelty classification training data may be updated iteratively on a feedback loop. As a non-limiting example, processor 144 may update novelty classification training data iteratively through a feedback loop as a function of novelty datum 112, commitment datum 108, output of target machine-learning model 160 or any machine-learning models and classifiers, resource categories 152, or the like. In some embodiments, processor 144 may be configured to generate novelty classifier 156. In a non-limiting example, generating novelty classifier 156 may include training, retraining, or fine-tuning novelty classifier 156 using novelty classification training data or updated novelty classification training data. In some embodiments, processor 144 may be configured to classify novelty datum 112 into one or more resource categories 152 using novelty classifier 156 (i.e. trained or updated novelty classifier 156). In some embodiments, a user may be classified to a user cohort as described in this disclosure and processor 144 may classify novelty datum 112 into one or more resource categories 152 based on the user cohort using a machine-learning module as described in detail with respect to FIG. 4 and the resulting output may be used to update novelty classification training data. In some embodiments, generating training data and training machine-learning models may be simultaneous. In some embodiments, processor 144 may adjust weights or connections between novelty datum 112 and resource categories 152 as described below.

With continued reference to FIG. 1, additionally, resource category 152 and method of classifying novelty datum 112 disclosed herein may be consistent with efficiency category and method of classifying occupational data described in U.S. patent application Ser. No. 18/405,537, filed on Jan. 5, 2024, titled “APPARATUS AND METHODS FOR THE GENERATION AND IMPROVEMENT OF EFFICIENCY DATA,” having an attorney docket number of 1452-042USU1, which is incorporated herein by reference herein in its entirety.

With continued reference to FIG. 1, processor 144 is configured to determine efficiency data 164 as a function of one or more resource categories 152. As used in the current disclosure, “efficiency data” is an element of data that is associated with the efficiency of the user while completing one or more tasks or activities. In a non-limiting example, the efficiency of user may be described in terms of how a user spends their time, money, resource, or the like. In some embodiments, efficiency data 164 may refer to the quantitative and qualitative measures used to evaluate how effectively and productively an individual utilizes their time, resources, and skills to accomplish tasks and contribute to the organization's goals. In a non-limiting example, an efficient user may spend most of their time on task, whereas an inefficient user may spend a significant amount of time on unproductive tasks or waste time as compared to their peers when completing tasks. In another non-limiting example, an inefficient user may spend unnecessarily large amount of time to do an activity. In some embodiments, efficiency data 164 may additionally refer to information that is collected and analyzed to evaluate the efficiency and output of a user. Efficiency data 164 may provide insights into an individual's performance and help assess their efficiency in various aspects of their work. In some embodiments, efficiency data 164 may include an evaluation of how well a user completes their assigned tasks; this data may measure the time taken by an individual to complete specific tasks or assignments. In a non-limiting example, efficiency data 164 may determine how efficiently a user executes their responsibilities and meet deadlines. In some cases, efficiency data 164 may include insights into how effectively they allocate their time and identify areas where time is being wasted or underutilized. When evaluating the efficiency of the user (e.g., efficiency data 164) may additionally take into consideration the quality of the user's work product. This may involve measuring the quantity and quality of work produced by an individual in resource category 152. This data may include metrics such as the number of projects completed, sales achieved, reports generated, or customer satisfaction ratings, and the like. In some embodiments, efficiency data 164 may include a determination of an error rate. As used in the current disclosure, an “error rate” is the number of errors caused by the user while completing task. An error rate may indicate the frequency and severity of errors made by an individual. This data may help assess the users attention to detail, accuracy, and the need for improvements in their work processes. In some embodiments, processor 144 may generate efficiency data 164 by comparing the estimated completion time to occupational data 112. The occupational data 112 may describe the tasks that were assigned to the user and the estimated completion time will describe how long each task should take. This may be compared to how much time it took the user to complete the task, including how much time the user spent on task versus unproductive time. Excessive unproductive time may negatively affect the efficiency data 164.

With continued reference to FIG. 1, in some embodiments, efficiency data 164 may be expressed as a numerical score or a linGUI 128stic value. Efficiency data 164 may be represented as a score used to reflect the current productivity of the user. A non-limiting example, of a numerical scale, may include a scale from 1-10, 1-100, 1-1000, and the like, wherein a rating of 1 may represent a user who is unproductive, whereas a rating of 10 may represent a user who is highly productive. Examples of linGUI 128stic values may include, “Unproductive,” “Below Average Efficiency,” “Average Efficiency,” “Good Efficiency,” “Excellent Efficiency,” and the like. In some embodiments, a numerical score range may be represented by a linGUI 128stic value. As used in the current disclosure, a “numerical score range” is a range of scores that are associated with a linGUI 128stic value. For example, this may include a score of 0-2 representing “Unproductive” or a score of 8-10 representing “Excellent Efficiency.” A user's efficiency may be scored by classifying novelty datum 112 or resource category 152 to examples of efficiency data 164 from third parties who are similarly situated by experience, job title, task, and overall productivity.

With continued reference to FIG. 1, a numerical score range representing efficiency data 164 may be adjusted using linGUI 128stic values. Processor 144 may adjust the numerical score range according to the desired level of efficiency from the user. A numerical score range may be determined by comparing the desired level of production from the user to previous iterations of the numerical score ranges. Previous iterations' numerical score ranges may be taken from users who are similarly situated to the current user by experience, job title, task, and overall productivity, and the like. Previous iterations of a numerical score range may be received from database 150. A numerical score range may be generated using a range machine-learning model. As used in the current disclosure, a “range machine-learning model” is a machine-learning model that is configured to identify a numerical score range. The range machine-learning model may be consistent with the machine-learning model described below in FIG. 4. Inputs to the range machine-learning model may include novelty datum 112, commitment datum 108, resource category 152, estimated completion times, examples of numerical score ranges, and the like. Outputs to the range machine-learning model may include a numerical score range. Range training data is a plurality of data entries containing a plurality of inputs that are correlated to a plurality of outputs for training a processor by a machine-learning process to correlate efficiency data 164 to examples of numerical score ranges. Range training data may be received from database 150. Range training data may contain information about novelty datum 112, commitment datum 108, resource category 152, estimated completion times, examples of numerical score ranges, and the like. Range training data may comprise correlations between efficiency data 164 to examples of numerical score ranges. Machine-learning model may be performed using, without limitation, linear classifiers such as without limitation logistic regression and/or I Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, in some embodiments, processor 144 may be configured to generate efficiency data 164 using an efficiency machine-learning model 168. As used in the current disclosure, an “efficiency machine-learning model” is a machine-learning model that is configured to generate efficiency data 164. The efficiency machine-learning model 168 may be consistent with the machine-learning model and/or the classifier as described below in FIG. 4. Inputs to the efficiency machine-learning model 168 may include novelty datum 112, commitment datum 108, resource category 152, estimated completion times, and the like. Outputs to the efficiency machine-learning model may include efficiency data 164 tailored to a user. Machine-learning models may be performed using, without limitation, linear machine-learning models such as without limitation logistic regression and/or I Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning models, learning vector quantization, and/or neural network-based machine-learning models. In some embodiments, processor 144 may be configured to generate efficiency training data. In a non-limiting example, efficiency training data may include correlations between exemplary resource categories and exemplary efficiency data. In some embodiments, efficiency training data may be stored in database 150. In some embodiments, efficiency training data may be received from one or more users, database 150, external computing devices, and/or previous iterations of processing. As a non-limiting example, efficiency training data may include instructions from a user, who may be an expert user, a past user in embodiments disclosed herein, or the like, which may be stored in memory and/or stored in database 150, where the instructions may include labeling of training examples. In some embodiments, efficiency training data may be updated iteratively on a feedback loop. As a non-limiting example, processor 144 may update efficiency training data iteratively through a feedback loop as a function of novelty datum 112, commitment datum 108, output of target machine-learning model 160, output of novelty classifier 156, output of efficiency machine-learning model 168, output of any machine-learning models and classifiers described herein, resource categories 152, efficiency data 164, or the like. In some embodiments, processor 144 may be configured to generate obstacle machine-learning model 172. In a non-limiting example, generating obstacle machine-learning model 172 may include training, retraining, or fine-tuning obstacle machine-learning model 172 using efficiency training data or updated efficiency training data. In some embodiments, processor 144 may be configured to generate efficiency data 164 using obstacle machine-learning model 172 (i.e. trained or updated obstacle machine-learning model 172). In some embodiments, a user may be classified to a user cohort as described in this disclosure and processor 144 may generate efficiency data 164 based on the user cohort using a machine-learning module as described in detail with respect to FIG. 4 and the resulting output may be used to update efficiency training data. In some embodiments, generating training data and training machine-learning models may be simultaneous. In some embodiments, processor 144 may adjust weights or connections between resource categories 152 and efficiency data 164 as described below.

With continued reference to FIG. 1, additionally, additional disclosure related to efficiency data 164 and method of generating efficiency data 164 disclosed herein may be found in U.S. patent application Ser. No. 18/405,537, filed on Jan. 5, 2024, titled “APPARATUS AND METHODS FOR THE GENERATION AND IMPROVEMENT OF EFFICIENCY DATA,” having an attorney docket number of 1452-042USU1, which is incorporated herein by reference herein in its entirety.

With continued reference to FIG. 1, in addition, in one or more embodiments, computing device 104 is configured to generate skill factor datum 116. More particularly, skills can be divided into domain-general and domain-specific skills. For example, in the domain of work (e.g., productive employment), some general skills may include time management, teamwork and leadership, self-motivation and others, whereas domain-specific skills would be used only for a certain job, such as practicing as a physician or as an attorney. In some embodiments, skill may require deployment in certain environmental stimuli and situations to assess the level of skill being shown and used. Further, a skill may be called an “art” when it represents a body of knowledge or branch of learning, as in the “art of medicine” or the “art of war.” Although the arts are also skills, there are many skills that form an “art” as so described here but have no subject matter connection to the fine and/or performing arts.

More particularly, skill factor datum 116 may be generated by computing device 104 (as to be further described below) as a function of novelty datum 112. In the context of banking, an example skill or qualification of a loan officer may be or include financial, time management, software, customer service, thoroughness, and analytical skills. In this example, skill factor datum 116 may be a skill that allowed the user to achieve novelty datum 112 and may include an identification of the skill and/or an evaluation of the improvement/acquisition of the skill that prompted the user to overcome an obstacle and achieve the improvement as indicated by novelty datum 112. In the context of banking in challenging macroeconomic circumstances as dictated by higher-than-expected federal interest rates, skill factor datum 116 may be the skill of a loan officer in adeptly identifying risky borrowers to reject their loan applications to thereby, because of the rejection initiated by the loan officer, improve overall performance of the bank.

With continued reference to FIG. 1, in addition, in one or more embodiments, skill factor datum 116 may include or describe a skill improvement datum (not shown in FIG. 1), which may include data describing providing the user with various tips, exercises, and instructions on how to improve skill factor datum 116. For example, returning to the context of a loan officer of a bank, a suitable skill improvement datum may describe educational activities undertaken by the loan officer to improve their analytical and/or decision-making skills to identify key positive or negative indicators demonstrated by loan applicants to approve of only quality applicants capable of timely repaying their respective outstanding loan obligations.

With continued reference to FIG. 1, more particularly, in some embodiments, generating skill factor datum 116 as a function of novelty datum 112 may include digitally assessing one or more categories of each skill the user used to achieve various performance-related improvement as indicated by novelty datum 112. In addition, one or more instances of skill factor datum 116 may be classified, by classifier 124 of machine-learning module 120 executed by processor 144, to novelty datum 112. Further, in some embodiments, skill factor datum 116 may be aggregated based on classification by classifier 124 to produce “better results” for the user, where “better results” are used herein and defined as identification of one or more instances of skill factor datum 116 that more closely and/or accurately present skills related to the user efficiently achieving target datum 118. In addition, in one or more embodiments, when multiple (e.g., two or more) skill factors are classified by classifier 124 to novelty datum 112, described processes may result in the selection and presentation to the user of multiple instances of skill factor datum 116 based on the classification.

Still further, in one or more embodiments, skill factor datum 116 may describe one or more elements, datum, or data describing confidence levels of the user. “Confidence,” as used herein, is defined as a state of having complete mental clarity relating to that a hypothesis or prediction is correct, or that a chosen course of action is the best or most effective in a given scenario or circumstance. Accordingly, “self-confidence,” as used herein, is defined as having trust in one's self—to, for example, successfully complete a work assignment on time, or to progress in physical training by achieving new milestones on an as-expected basis, with commensurate adjustments and improvements to eat only a healthy and “clean” diet, with limited to no processed foods and/or refined sugars, etc. Confidence, therefore, can impact the user's ability to favorably respond to social influences, as to be described further below.

With continued reference to FIG. 1, for example, an individual's self-confidence can vary in different environments, such as at home or in school, and with respect to different types of relationships and situations. In relation to general society, some have found that the more self-confident an individual is, the less likely they are to conform to the judgments of others. Other studies indicate that self-confidence in an individual's ability may only rise or fall where that individual is able to compare themselves to others who are roughly similar in a competitive environment. Furthermore, when individuals with low self-confidence receive feedback from others, they are averse to receiving information about their relative ability and negative informative feedback, yet still not averse to receiving positive feedback.

With continued reference to FIG. 1, aspects of the present disclosure recognize that, in some instances, people with relatively high self-confidence can more easily impress others, as others perceive them as more knowledgeable and more likely to make correct judgments. Accordingly, skill factor datum 116 can include or otherwise describe data representing at least the various above-described forms of confidence and/or self-confidence. For example, confidence may be demonstrated by a user attending a conference, or by delivering a keynote address at that conference. Different attributes may be correlated to each of those tasks—that is, attending the conference may be represented by data describing a relatively lower confidence level, whereas delivering the keynote address may be represented by data describing a relatively higher confidence level.

With continued reference to FIG. 1, accordingly, concepts relating to confidence can be quantified by one or more elements, datum or data and thereby processed by “machine-learning processes” executed by machine-learning module 120 of computing device 104 to, for example, be evaluated prior to display of multiple instances of skill factor datum 116 (e.g., the first skill factor datum and at least the second skill factor datum) hierarchically based on user-input datum 224A in user input field 148. More particularly, and as described further herein with relation to FIG. 4, a “machine-learning process,” as used in this disclosure, is a process that automatedly uses training data to generate an algorithm that will be performed by a computing device/module (e.g., computing device 104 of FIG. 1) to produce outputs given data provided as inputs. Any machine-learning process described in this disclosure may be executed by machine-learning module 120 of computing device 104 to manipulate and/or process skill factor datum 116 relating to describing instances or characteristics of confidence for the user.

With continued reference to FIG. 1, “training data,” as used herein, is data containing correlations that a machine-learning process may use to model relationships between two or more categories of data elements. For instance, and without limitation, training data, in this instance, may include multiple data entries, each entry representing a set of data elements that were recorded, received, and/or generated together and described various confidence levels or traits relating to demonstrations of confidence. Data elements may be correlated by shared existence in a given data entry, by proximity in a given data entry, or the like. Multiple categories of data elements may be related in training data according to various correlations, which may indicate causative and/or predictive links between categories of data elements, which may be modeled as relationships such as mathematical relationships by machine-learning processes as described in further detail below. In addition, training data may be formatted and/or organized by categories of data elements, for instance by associating data elements with one or more descriptors corresponding to categories of data elements.

With continued reference to FIG. 1, for instance, a supervised learning algorithm (or any other machine-learning algorithm described herein) may include one or more instances of skill factor datum 116 describing confidence of a user as described above as inputs. Accordingly, computing device 104 of FIG. 1 may receive user-input datum 224A into input field 148 of display device 132. User-input datum 224A may describe data for selecting a preferred attribute (e.g., such data describing “not always seeking approval from others,” “decisiveness,” “assertiveness,” “perseverance,” or other unique attributes of confidence, etc.) of any one or more skills associated with one or more instances of aggregated first skill factor datum (e.g., an instance of skill factor datum 116) and at least the second skill factor datum (e.g., another instance of skill factor datum 116). Classifier 124 of machine-learning module 120 may classify such data relative to, for example, target datum 118 (e.g., also in the context of confidence, such as achieving an optimum confidence level). Accordingly, in some embodiments, classifier 124 may classify instances of skill factor datum 116 that more closely relate to or resemble target datum 118 within a closer proximity to target datum 118.

With continued reference to FIG. 1, that is, for example, should target datum 118 describe the user deliver a keynote address in front of a large audience at a university graduation commencement ceremony, then classifier 124 may classify instances of skill factor datum 116 that more closely resemble target datum 118 closer to that particular instance of target datum 118. Examples of skill factor datum 116 include data describing the user delivering preparatory speeches in front of friends or data describing delivering practice speeches in front a mirror. In this example, classifier 124 may classify data describing delivering preparatory speeches in front of friends closer to target datum 118, given the relatively higher similarity of that task to target datum 118. Therefore, in some instances, described interface query data structures may configure display device 132 to display the first skill factor datum and at least the second skill factor datum hierarchically based on (e.g., conceptual similarity relative to) user-input datum 224A. That is, the hierarchical display of the first skill factor datum and at least the second skill factor datum are outputs responsive to at least the described training data being input into described machine-learning processes.

With continued reference to FIG. 1, in this way, a scoring function representing a desired form of relationship to be detected between inputs and outputs may be used by described machine-learning processes. Such as scoring function may, for instance, seek to maximize the probability that a given input (e.g., data describing perseverance relating to confidence) and/or combination of elements and/or inputs (e.g., data describing confidence overall) is associated with a given output (e.g., hierarchical display of multiple instances of skill factor datum 116 describing confidence) to minimize the probability that a given input (e.g., data describing potential over-confidence or recklessness) is not associated with a given output (e.g., additional stimuli encouraging confident or borderline reckless behavior).

With continued reference to FIG. 1, in addition, or the alternative, skill factor datum 116 can include or describe one or more elements, datum, or data relating to courage. “Courage,” as used herein, is defined as the choice and willingness to confront agony, pain, danger, uncertainty, or intimidation, in various circumstances ranging from business, interpersonal or romantic relationship, or combat. “Valor,” as used herein, is defined as courage or bravery, especially in battle. “Fortitude,” as used herein, is used interchangeably with “courage,” but also includes aspects of both perseverance and patience. Aspects of the present disclosure recognize that any one or more of courage, valor, and/or fortitude may be identified and tracked by one or more elements, datum, or data and thereby included or described by skill factor datum 116. For example, military service members may demonstrate great courage in infiltrating enemy lines in clear and present danger to their own lives and physical and mental well-being. Such traits of conduct can be tracked by service member response to military deployments and battle tactics. Consequently, skill factor datum 116 may be generated from data describing one or more of courage, valor and/or fortitude may by using machine-learning processes executed by machine-learning module 120 of computing device 104 and thereby be evaluated prior to display of multiple instances of skill factor datum 116 (e.g., the first skill factor datum and at least the second skill factor datum) hierarchically based on user-input datum 224A in user input field 148.

With continued reference to FIG. 1, similar to that discussed for usage of machine-learning processes to intake data describing user confidence levels, such machine-learning processes may in addition, or the alternative, intake data describing user courage, valor, or fortitude levels to correspondingly output multiple instances of skill factor datum 116 in a hierarchical format as relating to described aspects of courage. More particularly, in one or more embodiments, a supervised learning algorithm (or any other machine-learning algorithm described herein) may include one or more instances of skill factor datum 116 describing courage of a user as described above as inputs. Accordingly, computing device 104 of FIG. 1 may receive user-input datum 224A into input field 148 of display device 132. User-input datum 224A may describe data for selecting a preferred attribute (e.g., such data describing “willingness to confront difficult problems,” “setting a bold vision for the future,” “trustworthiness,” “endurance,” or other unique attributes of courage, etc.) of any one or more skills associated with one or more instances of aggregated first skill factor datum (e.g., an instance of skill factor datum 116) and at least the second skill factor datum (e.g., another instance of skill factor datum 116). Classifier 124 of machine-learning module 120 may classify such data relative to, for example, target datum 118 (e.g., also in the context of courage, such as achieving an optimum confidence level). Accordingly, in some embodiments, classifier 124 may classify instances of skill factor datum 116 that more closely relate to or resemble target datum 118 within a closer proximity to target datum 118.

With continued reference to FIG. 1, that is, for example, should target datum 118 describe the user carefully planning the surgical assault of an enemy stronghold while minimizing civilian and non-belligerent combatant casualties, then classifier 124 may classify instances of skill factor datum 116 that more closely resemble target datum 118 closer to that particular instance of target datum 118. Examples of skill factor datum 116 include data describing the user planning a tactical assault or data describing launching a long-term siege. In this example, classifier 124 may classify data describing planning a tactical assault closer to target datum 118, given the relatively higher similarity of that task to target datum 118. Therefore, in some instances, described interface query data structures may configure display device 132 to display the first skill factor datum and at least the second skill factor datum hierarchically based on (e.g., conceptual similarity relative to) user-input datum 224A. That is, the hierarchical display of the first skill factor datum and at least the second skill factor datum are outputs responsive to at least the described training data being input into described machine-learning processes.

With continued reference to FIG. 1, in addition, processor 144 is configured to determine at least an element of target datum 118. For the purpose of this disclosure, a “target datum” is an element, datum, or elements of data describing goal or object, either short or long term, desired for achievement by a user. In a non-limiting example, target datum 118 may include a goal desired for achievement by a user by conducting activities or tasks, which can be retrieved from commitment datum 108. In some embodiments, processor 144 may receive target datum 118 from user. In some embodiments, processor 144 may retrieve target datum 118 from database 150. In a non-limiting example, target datum 118 as described herein may be substantially the same as growth data and/or growth constraint profiles as used for higher-order growth modeling as described in U.S. patent application Ser. No. 18/141,725, filed on May 1, 2023, titled “APPARATUS AND A METHOD FOR HIGHER-ORDER GROWTH MODELING,” which is incorporated herein by reference herein in its entirety.

With continued reference to FIG. 1, in some instances, a goal may be or include an idea of the future or desired result that a person or a group of people envision, plan, and commit to achieve. In a professional or career-oriented context, goals can include milestones intended for achievement during the user's career, such as being invited to become an equity shareholder at a professional services firm, such as a law firm or an accounting firm, etc., or may include career changes or redirections, increases in salaries, or increases in supervisory expectations, such as having direct reporting personnel, or the like. Other specific examples of goals, targets, or other forms of achievement suitable for identification or tracking by target datum 118 include marked increases in core skills, such as in particular field of study, such as chemistry, chemical engineering, physics, astronomy, etc. Still further, target datum 118 may describe data relating to performance in interpersonal relationships, such as meeting new friends through activity groups, or increase romantic dating exposure by satisfactorily communicating key criteria, such as identify verification, etc. In some embodiments, the user (e.g., which may be just one person, or multiple persons organized into one or more groups of people) may endeavor to reach goals within a finite time by setting deadlines. Consequently, target datum 118 may, in some instances, include data describing a goal, which may be generally to a purpose or aim, the anticipated result which GUI 128 des reaction, or an end, which is an object, either a physical object or an abstract object, that has intrinsic value.

With continued reference to FIG. 1, in some embodiments, target datum 118 may be stored in database 150 and processor 144 may retrieve target datum 118 from database 150. In some embodiments, user may manually input target datum 118. In some embodiments, processor 144 is configured to determine target datum as a function of commitment datum 108 and conditions data. As used herein, “conditions data” is data related to conditions that may affect accomplishing a target or goal. In a nonlimiting example, conditions data may include financial information that affects a vocational goal, such as wage growth in a specific sector. In another nonlimiting example, conditions data may include increases in price index of items related to pecuniary goals, such as increases in prices for commonly bought grocery items. In some embodiments, conditions data may be stored in database 150 and processor 144 may retrieve conditions data from database 150. In some embodiments, user may manually input conditions data.

With continued reference to FIG. 1, in some embodiments, processor 144 may be configured to determine target datum 118 as a function of a target machine-learning model 160. In some embodiments, target machine-learning model 160 may be trained using target training data. In some embodiments, processor 144 may receive or generate target training data. Inputs to target machine-learning model 160 may include, as nonlimiting examples, financial statements, physical attributes, such as Body Mass Index (BMI) number, employment data, education level, and any commitment datum 108 and conditions data thereof. Outputs, as nonlimiting examples, may include targets or goals such as improving finances, reducing weight, change of employment, and the like. Target training data may include exemplary inputs correlated to exemplary outputs, such mock data. In some embodiments, target training data may be stored in database 150. In some embodiments, target training data may be received from one or more users, database 150, external computing devices, and/or previous iterations of processing. As a non-limiting example, target training data may include instructions from a user, who may be an expert user, a past user in embodiments disclosed herein, or the like, which may be stored in memory and/or stored in database 150, where the instructions may include labeling of training examples. In some embodiments, target training data may be updated iteratively on a feedback loop. As a non-limiting example, processor 144 may update target training data iteratively through a feedback loop as a function of output of classifier or machine-learning model described herein, commitment datum 108, or the like. In some embodiments, processor 144 may be configured to generate target machine-learning model 160. In a non-limiting example, generating target machine-learning model 160 may include training, retraining, or fine-tuning target machine-learning model 160 using target training data or updated target training data. In some embodiments, processor 144 may be configured to determine target datum 118 using target machine-learning model 160 (e.g., trained or updated target machine-learning model 160). In embodiments, target training data may include prior iterations of target machine-learning model 160. Target training data, in embodiments, may include prior target datum 118 generated for a user. In some embodiments, target training data may include prior target datum 118 generated for other users. In embodiments, target training data may include data inputted by a user, such as through a form. In some embodiments, target training data may be labelled by a user. In some embodiments, target training data may include data inputted by a user through display device. Target machine-learning model 160 and target training data may be consistent with any machine-learning model and training data described below. In some embodiments, user may be classified to a user cohort using a cohort classifier. Cohort classifier may be consistent with any classifier discussed in this disclosure. Cohort classifier may be trained on cohort training data, wherein the cohort training data may include user data correlated to user cohorts. In some embodiments, a user may be classified to a user cohort and processor 144 may determine target datum 118 based on the user cohort using a machine-learning module as described in detail with respect to FIG. 4 and the resulting output may be used to update target training data. In some embodiments, generating training data and training machine-learning models may be simultaneous. In some embodiments, processor 144 may further be configured to adjust weights between commitment datum 108, conditions data and/or target datum 118.

With continued reference to FIG. 1, additionally, target datum 118 and method of determining target datum 118 disclosed herein may be consistent with user goal and method of determining user goal described in U.S. patent application Ser. No. 18/142,656, filed on May 3, 2023, titled “APPARATUS AND METHOD FOR DIRECTED PROCESS GENERATION,” having an attorney docket number of 1452-008USU1, which is incorporated herein by reference herein in its entirety.

With continued reference to FIG. 1, in one or more embodiments, apparatus 100 for providing a skill factor hierarchy to a user is described. Apparatus 100 includes at least processor 144 and memory component 140 connected to the processor. The memory contains instructions configuring processor 144 to receive commitment datum 108 describing a pattern that is representative of user activity progressing to match target datum 118, identify novelty datum 112 as a function of commitment datum 108 and identify a first skill factor datum (e.g., one instance of skill factor datum 116) as a function of the novelty datum. Refining the first skill factor datum further includes classifying novelty datum 112 to the first skill factor datum and aggregating the first skill factor datum with at least a second skill factor (e.g., another instance of skill factor datum 116) datum based on the classification. In addition, either skill factor datum further includes data describing an obstacle traversal by the user.

With continued reference to FIG. 1, in some embodiments, processor 144 may be configured to generate an extended target datum 176. For the purposes of this disclosure, an “extended target datum” is the element of target datum describing a goal that a user can target to achieve, either short or long term, which is aims for improved results compared to the user's previous goal. In a non-limiting example, extended target datum 176 may include a goal that is set based on the user's skill and a previous goal. As a non-limiting example, extended target datum 176 may be consistent with target datum 118 described above but with bigger or better goal that can increase efficiency data 164. For example, and without limitation, if target datum 118 is ‘earning $10,000,’ then extended target datum 176 may be ‘earning $100,000.’ In some embodiments, user may manually input extended target datum 176. In some embodiments, extended target datum 176 may be stored in database 150 and processor 144 may retrieve extended target datum 176 from database 150.

With continued reference to FIG. 1, in some embodiments, processor 144 may be configured to determine extended target datum 176 as a function of a goal setting machine-learning model. In some embodiments, goal setting machine-learning model may be trained using goal setting training data. As a non-limiting example, goal setting training data may include correlations between exemplary target datums, exemplary skill factor datums, and exemplary extended datums. Goal setting training data may include exemplary inputs correlated to exemplary outputs, such mock data. In some embodiments, processor 144 may receive or generate goal setting training data. In some embodiments, goal setting training data may be stored in database 150. In some embodiments, goal setting training data may be received from one or more users, database 150, external computing devices, and/or previous iterations of processing. As a non-limiting example, goal setting training data may include instructions from a user, who may be an expert user, a past user in embodiments disclosed herein, or the like, which may be stored in memory and/or stored in database 150, where the instructions may include labeling of training examples. In some embodiments, goal setting training data may be updated iteratively on a feedback loop. As a non-limiting example, processor 144 may update goal setting training data iteratively through a feedback loop as a function of output of target machine-learning model 160, output of factor machine-learning model, output of any classifier or machine-learning model described herein, commitment datum 108, target datum 118, skill factor datum 116, commitment datum 108, novelty datum 112, extended target datum 176, or the like. In some embodiments, processor 144 may be configured to generate goal setting machine-learning model. In a non-limiting example, generating goal setting machine-learning model may include training, retraining, or fine-tuning goal setting machine-learning model using goal setting training data or updated goal setting training data. In some embodiments, processor 144 may be configured to determine target datum 118 using goal setting machine-learning model (e.g., trained or updated goal setting machine-learning model). In embodiments, goal setting training data may include prior iterations of goal setting machine-learning model. Goal setting training data, in embodiments, may include prior extended target datum 176 generated for a user. In some embodiments, goal setting training data may include prior extended target datum 176 generated for other users. In embodiments, goal setting training data may include data inputted by a user, such as through a form. In some embodiments, goal setting training data may be labelled by a user. In some embodiments, goal setting training data may include data inputted by a user through display device. Goal setting machine-learning model and goal setting training data may be consistent with any machine-learning model and training data described below. In some embodiments, user may be classified to a user cohort using a cohort classifier. Cohort classifier may be consistent with any classifier discussed in this disclosure. Cohort classifier may be trained on cohort training data, wherein the cohort training data may include user data correlated to user cohorts. In some embodiments, a user may be classified to a user cohort and processor 144 may determine extended target datum 176 based on the user cohort using a machine-learning module as described in detail with respect to FIG. 4 and the resulting output may be used to update goal setting training data. In some embodiments, generating training data and training machine-learning models may be simultaneous. In some embodiments, processor 144 may further be configured to adjust weights between target datum 118, skill factor datum 116, and/or extended target datum 176.

With continued reference to FIG. 1, processor 144 is configured to determine at least an obstacle datum 180. Processor 144 is configured to determine obstacle datum 180 as a function of target datum 118 and skill factor datum 116. In some embodiments, processor 144 may determine obstacle datum 180 as a function of extended target datum 176. An “obstacle datum,” as used herein, is an element of data describing conditions that negatively impact achievement of a user's goal. In a nonlimiting example, obstacle datum 180 may include a heart condition of the user that may affect a fitness goal. In another non-limiting example, obstacle datum 180 may include a lack of skill of a user. In another nonlimiting example, obstacle datum 180 may include a requirement for pursuing an advanced academic degree that may affect a user's educational goal. In another non-limiting example, obstacle datum 180 may include lack of financial resource, human resource, physical resource, or the like. In some embodiments, user may manually input obstacle datum 180. In some embodiments, obstacle datum 180 may be stored in database 150 and processor 144 may retrieve obstacle datum 180 from database 150.

With continued reference to FIG. 1, in some embodiments, processor 144 may be configured to generate obstacle datum 180 using an obstacle machine-learning model 172. In some embodiments, processor 144 may be configured to generate obstacle training data. In a non-limiting example, obstacle training data may include correlations between exemplary target datums, exemplary extended target datums, exemplary skill factor datums and exemplary obstacle datums. In some embodiments, obstacle training data may be stored in database 150. In some embodiments, obstacle training data may be received from one or more users, database 150, external computing devices, and/or previous iterations of processing. As a non-limiting example, obstacle training data may include instructions from a user, who may be an expert user, a past user in embodiments disclosed herein, or the like, which may be stored in memory and/or stored in database 150, where the instructions may include labeling of training examples. In some embodiments, obstacle training data may be updated iteratively on a feedback loop. As a non-limiting example, processor 144 may update obstacle training data iteratively through a feedback loop as a function of novelty datum 112, commitment datum 108, output of target machine-learning model 160, output of novelty classifier 156, output of target machine-learning model 160, output of obstacle machine-learning model 172, output of any machine-learning models and classifiers described herein, resource categories 152, efficiency data 164, target datum 118, extended target datum 176, obstacle datum 180, skill factor datum 116, or the like. In some embodiments, processor 144 may be configured to generate obstacle machine-learning model 172. In a non-limiting example, generating obstacle machine-learning model 172 may include training, retraining, or fine-tuning obstacle machine-learning model 172 using obstacle training data or updated obstacle training data. In some embodiments, processor 144 may be configured to generate obstacle datum 180 using obstacle machine-learning model 172 (i.e. trained or updated obstacle machine-learning model 172). In some embodiments, a user may be classified to a user cohort as described in this disclosure and processor 144 may generate obstacle datum 180 based on the user cohort using a machine-learning module as described in detail with respect to FIG. 4 and the resulting output may be used to update obstacle training data. In some embodiments, generating training data and training machine-learning models may be simultaneous. In some embodiments, processor 144 may adjust weights or connections between target datum 118, extended target datum 176, skill factor datum 116, and obstacle datum 180 as described below.

Still referring to FIG. 1, in embodiments, processor 144 is further configured to generate a directed process 184 as a function of obstacle datum 180. A “directed process,” as used herein, are a set of steps required to achieve a user's goal or target. Directed process 184 includes a set of instructions to improve efficiency data 164. As a non-limiting example, directed process 184 may include a set of instructions to improve a user's efficiency for managing time resource, financial resource, human resource, and physical resource. In some embodiments, processor 144 may generate a directed process 184 as a function of obstacle datum 180 and extended target datum 176. In an embodiment, directed process 184 may include a plurality of instructions regarding how to achieve target datum 118 or extended target datum 176. In some embodiments, directed process 184 may be target datum 118 or extended target datum 176 broken down into a series of sub-goals. In some embodiments, the sub-goals may be smaller or more simple goals used to progress the user towards target datum 118 or extended target datum 176. In a nonlimiting example, if processor 144 generates target datum 118 or extended target datum 176 of purchasing a car, directed process 184 may include the steps of 1. identifying a user's credit, which may be a condition of low score; 2. identifying a price range; 3. promoting the users to increase credit score, which may include the sub-step of paying-off credit card debt; 4. identifying a vehicle within the price range of the user; 5. getting financing on the purchase based on credit score; and 6. generating an offer for purchase of the car. Additionally, directed process 184 may include combination of steps and sub steps. A step may include a task that a user must complete to achieve target datum 118 or extended target datum 176. Once a user has achieved a plurality of steps and subs-steps the user may achieve a waypoint. A “waypoint,” as used herein, is at least a step required for performing all the steps in directed process 184. In embodiments, directed process 184 may include one or more waypoints. A further non-limiting example, a waypoint may be to increase credit rating to a certain score as to allow user to finance a purchase.

With continued reference to FIG. 1, in some embodiments, directed process 184 may be stored in database 150 and processor 144 may retrieve directed process 184 from database 150. In some embodiments, user may manually input directed process 184. In some embodiments, processor 144 may generate directed process 184 using a process machine-learning model 188. In some embodiments, processor 144 may be configured to generate process training data. In a non-limiting example, process training data may include correlations between exemplary target datums, exemplary extended target datums, exemplary skill factor datums, exemplary obstacle datums, exemplary efficiency data and/or exemplary directed processes. In some embodiments, process training data may be stored in database 150. In some embodiments, process training data may be received from one or more users, database 150, external computing devices, and/or previous iterations of processing. As a non-limiting example, process training data may include instructions from a user, who may be an expert user, a past user in embodiments disclosed herein, or the like, which may be stored in memory and/or stored in database 150, where the instructions may include labeling of training examples. In some embodiments, process training data may be updated iteratively on a feedback loop. As a non-limiting example, processor 144 may update process training data iteratively through a feedback loop as a function of novelty datum 112, commitment datum 108, output of target machine-learning model 160, output of novelty classifier 156, output of target machine-learning model 160, output of process machine-learning model 188, output of obstacle machine-learning model 172, output of any machine-learning models and classifiers described herein, resource categories 152, efficiency data 164, target datum 118, extended target datum 176, obstacle datum 180, skill factor datum 116, directed process 184, or the like. In some embodiments, processor 144 may be configured to generate process machine-learning model 188. In a non-limiting example, generating process machine-learning model 188 may include training, retraining, or fine-tuning process machine-learning model 188 using process training data or updated process training data. In some embodiments, processor 144 may be configured to generate directed process 184 using process machine-learning model 188 (i.e. trained or updated process machine-learning model 188). In some embodiments, a user may be classified to a user cohort as described in this disclosure and processor 144 may generate directed process 184 based on the user cohort using a machine-learning module as described in detail with respect to FIG. 4 and the resulting output may be used to update process training data. In some embodiments, generating training data and training machine-learning models may be simultaneous. In some embodiments, processor 144 may adjust weights or connections between target datum 118, extended target datum 176, skill factor datum 116, obstacle datum 180 and directed process 184 as described below.

With continued reference to FIG. 1, additional disclosure related to obstacle datum 180 and directed process 184 may be found in U.S. patent application Ser. No. 18/142,656, filed on May 3, 2023, titled “APPARATUS AND METHOD FOR DIRECTED PROCESS GENERATION,” having an attorney docket number of 1452-008USU1, which is incorporated herein by reference herein in its entirety.

With continued reference to FIG. 1, processor 144 is configured to generate an interface query data structure 136. Interface query data structure 136 configures a remote display device to display efficiency data 164 and directed process 184. In some embodiments, interface query data structure 136 of a remote display device to display obstacle datum 180, novelty datum 112, resource category 152, skill factor datum 116, target datum 118, extended target datum 176, or the like. In addition, processor 144 may be configured to generate an interface query data structure 136 including user input field 148 based on aggregations of skill factor datum 116. The interface query data structure configures display device 132 to display user input field 148 to the user and receive at least user-input datum 224A into the input field. The user-input datum 224A describes data for selecting a preferred attribute of any one or more skills associated with one or more instances of the aggregated first skill factor datum and at least the second skill factor datum and display the first skill factor and at least the second skill factor datum hierarchically based on user-input datum 224A.

With continued reference to FIG. 1, in one or more embodiments, generating the interface query data structure further includes retrieving data describing attributes of the user from the database and generating the interface query data structure based on the data describing attributes of the user. In addition, or in the alternative, in some embodiments, generating commitment datum 108 further includes retrieving data describing current preferences of the user between a minimum value and a maximum value from the database and generating the interface query data structure based on the data describing current preferences of the user.

With continued reference to FIG. 1, further, in some instances, receiving commitment datum 108 further includes extracting commitment datum 108 from the database using scripts. In addition, or in the alternative, extracting commitment datum 108 from the database further includes tracking data describing one or more activities of the user on the Internet. Still further, in some embodiments, receiving commitment datum 108 includes receiving commitment datum 108 using data scrapers and/or evaluating data derived from external entities.

With continued reference to FIG. 1, in some embodiments, novelty datum 112 includes data describing one or more activities completed by the user, where the one or more activities relate to the user matching the target. In addition, in one or more instances, novelty datum 112 includes data describing changes in resource sharing for the user matching the target.

With continued reference to FIG. 1, in one or more embodiments, processor 144 may be configured to evaluate user-input datum 224A by using a feedback loop, which is defined as using the classifier for classifying one or more new instances of user-input datum 224A with the first skill factor datum and the second skill factor datum. The feedback loop includes generating a consecutive skill factor datum based on the classification and displaying the first skill factor, the second skill factor datum, and at least the consecutive skill factor datum hierarchically based on the classification of the consecutive skill factor datum to one or more new instances of the user-input datum.

With continued reference to FIG. 1, in some instances, classifying novelty datum 112 to at least the first skill factor datum further includes aggregating the first skill factor datum with at least a second skill factor datum based on the classification and further classifying aggregated data to data describing a frequency of implementation of the first skill factor datum and the second skill factor datum to the target. In addition, in some embodiments, the interface query data structure further configures display device 132 to provide an articulated graphical display including multiple regions organized in a tree structure format, where each region provides one or more instances of point of interaction between the user and the remote display device.

With continued reference to FIG. 1, in addition, in one or more embodiments, classifier 124 may classify and/or correlate only a select portion of one or more instances of any one or more of commitment datum 108, novelty datum 112, skill factor datum 116, and/or target datum 118 (e.g., which may be user-defined and input into computing device 104 through interaction with user input field 148 of display device 132) with data describing at least some user attributes 154 and/or instances of external entity interaction datum. More particularly, the described processes do not always require that all occurrences of each described datum are classified and/or correlated with user attributes 154 and/or instances of external entity interaction datum 158. For example, described processes may classify or correlate select portions of occurrences of commitment datum 108 and/or novelty datum 112 with select portions of user attributes 154. In addition, each occurrence of user attributes 154 may not have a corresponding commitment datum.

With continued reference to FIG. 1, for example, certain user attributes may be deemed not particularly relevant to commitment datum 108 to thereby not have a corresponding instance attribute within user attributes 154. As a result, such, as well as other forms of, data may “train” described machine-learning processes to iteratively refine described data and provide a customized skill factor datum to a user in a particular operational condition.

With continued reference to FIG. 1, in one or more embodiments, processor 144 of computing device 104 may be configured to execute described machine-learning processes by machine-learning module 120 to generate or populate training data, which may include requesting a human or a computer (not shown in FIG. 1) communicatively connected to computing device 104 to input data describing a pattern that is representative of user activity progressing to match target datum 118 through user input field 148 of GUI 128 of display device 132. Human or computer-provided input may be binary in certain circumstance, e.g., a “yes” or “no,” or include phrases or sentences provided in text format that the described machine-learning processes may recognize using text-recognition or another applicable data processing technique. Human or computer-provided responses may be incorporated into user attributes 154 to be later iteratively correlated by relative applicability to, for example, the business and be potentially used with external entity interaction datum 158 to provide the customized skill factor datum as described.

With continued reference to FIG. 1, after initial training, machine-learning processes (to be described in further detail below) may classify one or more instances of any one or more of commitment datum 108, novelty datum 112, skill factor datum 116, and/or target datum 118 to user attributes 154 and/or external entity interaction datum 158 to provide the customized skill factor datum to the user.

With continued reference to FIG. 1, in one or more embodiments, database 150 may include inputted or calculated information and data (e.g., data related to one or more instances of any one or more of commitment datum 108, novelty datum 112, skill factor datum 116, and/or target datum 118, as well as user attributes 154 and/or external entity interaction datum 158) related to providing the customized skill factor datum to the user. In addition, a datum history may be stored in a database 150. Datum history may include real-time and/or previously inputted to one or more instances of any one or more of commitment datum 108, novelty datum 112, skill factor datum 116, and/or target datum 118. In one or more embodiments, database 150 may include real-time or previously determined record recommendations and/or previously provided interaction preparations. Computing device 104 may be communicatively connected with database 150.

With continued reference to FIG. 1, for example, and without limitation, in some cases, database 150 may be local to computing device 104. In another example, and without limitation, database 150 may be remote to computing device 104 and communicative with computing device 104 by way of one or more networks. A network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which computing device 104 connects directly, dynamically, and non-hierarchically to as many other computing devices as possible. A “network topology” as used in this disclosure is an arrangement of elements of a communication network. Network may use an immutable sequential listing to securely store database 150. An “immutable sequential listing,” as used in this disclosure, is a data structure that places data entries in a fixed sequential arrangement, such as a temporal sequence of entries and/or blocks thereof, where the sequential arrangement, once established, cannot be altered, or reordered. An immutable sequential listing may be, include and/or implement an immutable ledger, where data entries that have been posted to the immutable sequential listing cannot be altered.

With continued reference to FIG. 1, database 150 may include keywords. As used in this disclosure, a “keyword” is an element of word or syntax used to identify and/or match elements to each other. For example, without limitation, a keyword may be “finance” in the instance that a business is seeking to optimize operations in the financial services and/or retirement industry. In another non-limiting example, keywords of a key-phrase may be “luxury vehicle manufacturing” in an example where the business is seeking to optimize market share internationally, or certain rapidly developing markets. Database 150 may be implemented, without limitation, as a relational database, a key-value retrieval datastore such as a NOSQL database, or any other format or structure for use as a datastore that a person skilled in the art, upon reviewing the entirety of this disclosure, would recognize as suitable upon review of the entirety of this disclosure.

With continued reference to FIG. 1, computing device 104 is further configured to receive commitment datum 108, as previously mentioned. For the purposes of this disclosure, “entity datum” includes historical data of the entity. Historical data may include attributes and facts about a user already known, such as current inventory, total revenue, profit and loss, payroll information, transportation costs, operational costs, such as rent, utility bills, insurance rates, and the like. Commitment datum 108 may describe textual, audio and/or visual information related to the entity's operational information or attributes. In some embodiments, user attributes 154 and/or commitment datum 108 may describe textual, audio and/or visual information relating to the user demonstrating commitment through systematic completion of activities related to achieving target datum 118. User attributes 154 may be received by computing device 104 by identical or similar means described above for commitment datum 108 and/or novelty datum 112. For example, and without limitation, user attributes 154 may be provided to computing device 104 by a human or computer (not shown in FIG. 1) communicatively connected with computing device 104 through, for example, a third-party application, remote device, immutable sequential listing, etc.

With continued reference to FIG. 1, a “classifier,” as used in this disclosure is type or operational sub-unit of any described machine-learning model or process executed by machine-learning module 120, such as a mathematical model, neural net, or program generated by a machine-learning algorithm known as a “classification algorithm” that distributes inputs into categories or bins of data, outputting the categories or bins of data and/or labels associated therewith. A classifier may be configured to classify and/or output at least a datum (e.g., one or more instances of any one or more of commitment datum 108, novelty datum 112, skill factor datum 116, and/or target datum 118 as well as other elements of data produced, stored, categorized, aggregated or otherwise manipulated by the described processes) that labels or otherwise identifies a set of data that are clustered together, found to be close under a distance metric, or the like.

With continued reference to FIG. 1, computing device 104 may be configured to identifying business impact by using classifier 124 to classify one or more instances of any one or more of commitment datum 108, novelty datum 112, skill factor datum 116, and/or target datum 118 based on user attributes 154 and/or external entity interaction datum 158. Accordingly, classifier 124 of machine-learning module 120 may classify attributes within user attributes 154 related to demonstrating commitment toward reaching target datum 118 for providing the customized skill factor datum to the user.

With continued reference to FIG. 1, in addition, in some embodiments, machine-learning module 120 performing the described correlations may be supervised. Alternatively, in other embodiments, machine-learning module 120 performing the described correlations may be unsupervised. In addition, classifier 124 may label various data (e.g., one or more instances of any one or more of commitment datum 108, novelty datum 112, skill factor datum 116, and/or target datum 118 as well as other elements of data produced, stored, categorized, aggregated, or otherwise manipulated by the described processes) using machine-learning module 120. For example, machine-learning module 120 may label certain relevant parameters of one or more instances of commitment datum 108 with parameters of one or more user attributes 154. In addition, machine-learning processes performed by machine-learning module 120 may be trained using one or more instances of external entity interaction datum 158 to, for example, more heavily weigh or consider instances of external entity interaction datum 158 deemed to be more relevant to the business. More specifically, in one or more embodiments, external entity interaction datum 158 may be based on or include correlations of parameters associated with commitment datum 108 to parameters of user attributes 154. In addition, external entity interaction datum 158 may be at least partially based on earlier iterations of machine-learning processes executed by machine-learning module 120. In some instances, running machine-learning module 120 over multiple iterations refines correlation of parameters or data describing entity operations (e.g., associated with commitment datum 108) with parameters describing at least user attributes 154.

With continued reference to FIG. 1, classification may be performed using, without limitation, linear classifiers such as without limitation logistic regression and/or I Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 1, computing device 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P (B/A) P(A)=P (B), where P(A/B) is the probability of hypothesis A given data B also known as posterior probability; P (B/A) is the probability of data B given that the hypothesis A was true; P(A) is the probability of hypothesis A being true regardless of data also known as prior probability of A; and P (B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, computing device 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

Further referring to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

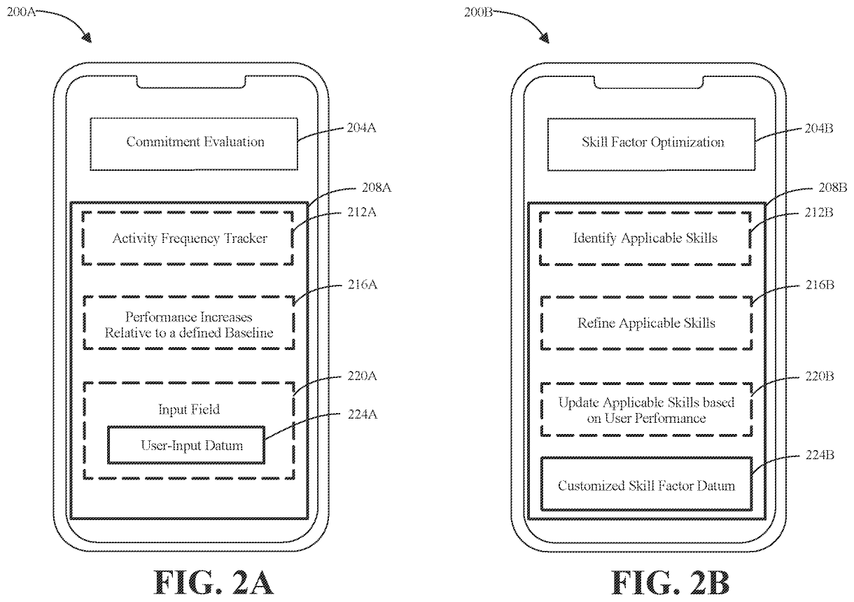

Referring now to FIGS. 2A-2B, exemplary embodiments of user input field 148 as configured to be displayed by GUI 128 of display device 132 based on an interface query data structure are illustrated. As defined earlier, an “interface query data structure” refers to, for example, a data organization format used to digitally request a data result or action on the data (e.g., stored in a database). In one or more embodiments, each output screen 200A-200B may be an example of an output screen configured to be displayed by display device 132 of FIG. 1 by an interface query data structure. That is, more particularly, interface query data structure may configure display device 132 of FIG. 1 to display any one or more of output screens 200A-200B as described in the present disclosure. Accordingly, output screen 200A may include multiple forms of indicia.

With continued reference to FIGS. 2A-2B, in one or more embodiments, output screen 200A and output screen 200B may be examples of user input field 148 and/or GUI 128 as displayed by display device 132, which may be a “smart” phone, such as an iPhone, or other electronic peripheral or interactive cell phone, tablet, etc. Output screen 200A may be a screen initially displayed to a user (e.g., a human or a human representing or acting on behalf of a business or some other entity, and have user engagement area 208A including identification field 204A, activity frequency tracker field 212A, performance monitoring field 216A, user-input field 220A, which may include one or more instances of user-input datum 224A describing data for selecting a preferred attribute of any one or more skills associated with one or more instances of the skill factor datum. In addition, in one or more embodiments, user input datum 224A may be reflective of and/or provide a basis for user attributes 154. Persons skilled in the art, upon reviewing the entirety of this disclosure, will be aware of various ways in which fewer or additional interactive user input fields may be displayed by screen 208A. Identification field 204A may identify described processes performed by processor 144 of computing device 104 by displaying identifying indicia, such as “Commitment Evaluation” as shown in FIG. 2A to permit, for example, a human to interact with GUI 128 and input information relating to a field of choice (e.g., business operations), through (for example) interactivity provided by identification field 204A.

With continued reference to FIGS. 2A-2B, such information can include data describing activities performed by the business relating to the business achieving its defined goal (e.g., target datum 118 of FIG. 1). In some instances, a human may select from one or more options (not shown in FIG. 2A) relating to prompts provided by identification field 204A to input such information relating to specific details of, for example, the business. In addition, in some embodiments, any of the described fields may include interactive features, such as prompts, permitting for a human to select additional textual and/or other digital media options further identifying or clarifying the nature of the business relating to the respective specifics of that field. For example, activity frequency tracker field 212A may display assessments of corresponding instruction sets regarding relevance and potential for positive impact on the business and may thereby also provide interactive features permitting the human to input additional data or information relating to expectations of positive of negative assessments for a given instruction set. Such additional human-input data may be computationally evaluated by described machine-learning processes executed by machine-learning module 120 and thereby correspondingly appear in the described progression sequence.

With continued reference to FIGS. 2A-2B, like output screen 200A, output screen 200B may be an example of a screen subsequently shown to a human as described earlier based on human-provided input to any one or more of the displayed fields. That is, output screen 200B may display “Skill Factor Optimization” in identification field 204B as indicating completion of intake of human-provided input and that described machine-learning processes have completed described classifying processes to output customized skill factor assessment area 208B to the user. For example, in one or more embodiments, customized skill factor assessment area 208B may also include multiple human-interactive fields, including skill identification field 212B, skill refinement field 216B, a skill update field 220B, and customized skill factor datum 224B generated as described earlier.

With continued reference to FIGS. 2A-2B, persons skilled in the art, upon reviewing the entirety of this disclosure, will be aware of various ways in which fewer or additional interactive human input fields may be displayed by output screen 200B. Each field within customized skill factor assessment area 208B may display any combination of human interactive text and/or digital media, each field intending to provide specific data-driven feedback directed to optimizing ongoing business performance of the business. Various example types of specifics (e.g., “decrease risky leverage in high interest rate conditions”) are shown in customized skill factor assessment area 208B, but persons skilled in the art will be aware of other example types of feedback, each of which being generated as suitable for a given business by processor 144. In addition, in one or more embodiments, any one or more fields of customized skill factor assessment area 208B may be human-interactive, such as by posing a query for the human to provide feedback in the form of input such that described machine-learning processes performed by machine-learning module 120 may intake refined input data and correspondingly process related data and provide an updated customized skill factor assessment area 208B. In some embodiments, such processes may be performed iteratively, thereby allowing for ongoing refinement, redirection, and optimization of customized skill factor assessment area 208B to better meet the needs of the business.

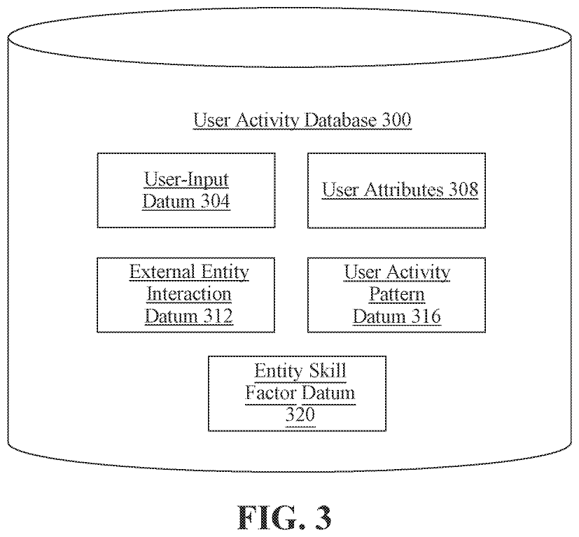

Referring now to FIG. 3, an exemplary embodiment of user activity database 300 is illustrated. In one or more embodiments, user activity database 300 may be an example of database 150 of FIG. 1. Query database may, as a non-limiting example, organize data stored in the user activity database according to one or more database tables. One or more database tables may be linked to one another by, for instance, common column values. For instance, a common column between two tables of expert database may include an identifier of a query submission, such as a form entry, textual submission, or the like, for instance as defined below; as a result, a query may be able to retrieve all rows from any table pertaining to a given submission or set thereof. Other columns may include any other category usable for organization or subdivision of expert data, including types of query data, identifiers of interface query data structures relating to obtaining information from the user, times of submission, or the like. Persons skilled in the art, upon reviewing the entirety of this disclosure, will be aware of various ways in which user activity data from one or more tables may be linked and/or related to user activity data in one or more other tables.

With continued reference to FIG. 3, in addition, in one or more embodiments, computing device 104 may be configured to access and retrieve one or more specific types of user attributes categorized in multiple tables from user activity database 300. For example, as shown in FIG. 3, user activity database 300 may be generated with multiple categories including user-input datum 304, user attributes 308, external entity interaction datum 312, user activity pattern datum 316 and entity skill factor datum 320, which describes various aspects of the “4Cs,” referring to customers, costs, convenience, and communication, of long-term business planning as introduced earlier. Consequently, described processes may receive user-input datum 304 into user input field 148 of FIG. 1, where the user-input datum may describe data for selecting a preferred attribute of any one or more skills associated with one or more instances of skill factor datum 116. In addition, described processes may retrieve data describing additional attributes related to the preferred attribute of skill factor datum 116 from user activity database 300 connected with the processor based on user-input datum 304 (e.g., or, alternatively, one or more of user attributes 308, external entity interaction datum 312, and/or user activity pattern datum 316, etc.).

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine-learning processes. A “machine-learning process,” as used in this disclosure, is a process that automatedly uses training data 404 to generate an algorithm instantiated in hardware or software logic, data structures, and/or functions that will be performed by a computing device/module to produce outputs 408 given data provided as inputs 412; this is in contrast to a non-machine-learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example, input data may include commitment datum 108, obstacle datum 180, target datum 118, extended target datum 176, directed process 184, novelty datum 112, skill factor datum 116, resource category 152, or the like. As a non-limiting illustrative example, output data may include obstacle datum 180, target datum 118, extended target datum 176, directed process 184, novelty datum 112, skill factor datum 116, resource category 152, or the like.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a data structure representing and/or using a mathematical model, neural net, or program generated by a machine-learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to a user cohort. For example, and without limitation, training data classifier 416 may classify elements of training data to a user cohort related to age, gender, company size, industry type, or the like.

Still referring to FIG. 4, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P (B/A) P(A)=P (B), where P(A/B) is the probability of hypothesis A given data B also known as posterior probability; P (B/A) is the probability of data B given that the hypothesis A was true; P(A) is the probability of hypothesis A being true regardless of data also known as prior probability of A; and P (B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 4, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 4, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 4, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 4, computer, processor, and/or module may be configured to preprocess training data. “Preprocessing” training data, as used in this disclosure, is transforming training data from raw form to a format that can be used for training a machine-learning model. Preprocessing may include sanitizing, feature selection, feature scaling, data augmentation and the like.

Still referring to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 4, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 4, computing device, processor, and/or module may be configured to precondition one or more training examples. For instance, and without limitation, where a machine-learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine-learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine-learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 4, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 4, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 4, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a medium value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 4, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine-learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include commitment datum 108, obstacle datum 180, target datum 118, extended target datum 176, directed process 184, novelty datum 112, skill factor datum 116, resource category 152, or the like as described above as inputs, obstacle datum 180, target datum 118, extended target datum 176, directed process 184, novelty datum 112, skill factor datum 116, resource category 152, or the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

With further reference to FIG. 4, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 4, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 4, machine-learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 432 may not require a response variable; unsupervised processes 432 may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task clastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 4, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 4, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 4, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 4, one or more processes or algorithms described above may be performed by at least a dedicated hardware unit 436. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 436 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 436 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 436 to perform one or more operations described herein, such as evaluation of model and/or algorithm outputs, one-time or iterative updates to parameters, coefficients, weights, and/or biases, and/or any other operations such as vector and/or matrix operations as described in this disclosure.

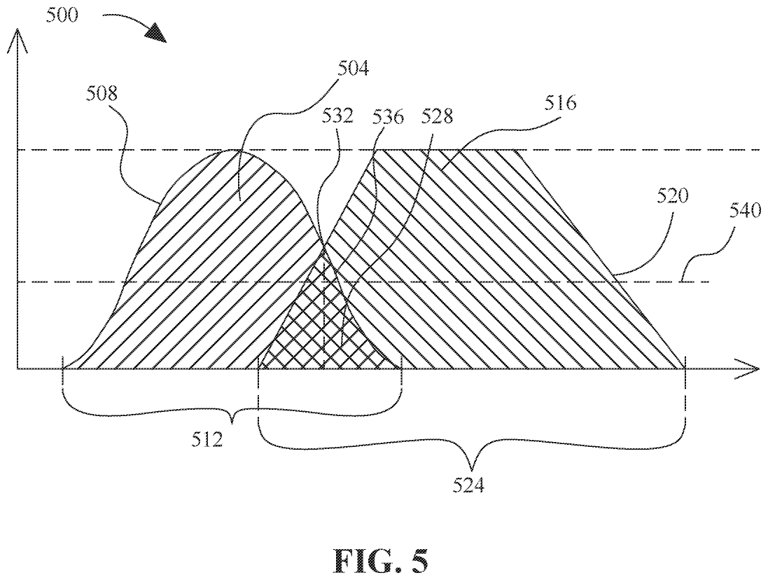

Referring to FIG. 5, an exemplary embodiment of fuzzy set comparison 500 is illustrated. In one or more embodiments, data describing any described process relating to providing a skill factor hierarchy to a user as performed by processor 144 of computing device 104 may include data manipulation or processing including fuzzy set comparison 500. In addition, in one or more embodiments, usage of an inference engine relating to data manipulation may involve one or more aspects of fuzzy set comparison 500 as described herein. That is, although discrete integer values may be used as data to describe, for example, one or more instances of any one or more of commitment datum 108, novelty datum 112, skill factor datum 116, and/or target datum 118, as well as external entity interaction datum 158 and/or user attributes 154, fuzzy set comparison 500 may be alternatively used. For example, a first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0, 1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range of values 512 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models, one or more instances of any one or more of commitment datum 108, novelty datum 112, skill factor datum 116, and/or target datum 118, as well as external entity interaction datum 158 and/or user attributes 154, and a predetermined class, such as without limitation, query data or information including interface query data structures stored in user activity database 300 of FIG. 3. A second fuzzy set 516, which may represent any value which may be represented by first fuzzy set 504, may be defined by a second membership function 520 on a second range of values 524; second range of values 524 may be identical and/or overlap with first range of values 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on probability interval, of a match between first fuzzy set 504 and second fuzzy set 516. Alternatively, or additionally, a single value of first and/or second fuzzy set may be located at a locus 536 on first range of values 512 and/or second range of values 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, threshold may indicate a sufficient degree of overlap between an output from one or more machine-learning models one or more instances of any one or more of commitment datum 108, novelty datum 112, skill factor datum 116, and/or target datum 118, as well as external entity interaction datum 158 and/or user attributes 154 and a predetermined class, such as without limitation, query data categorization, for combination to occur as described above. Alternatively, or additionally, each threshold may be tuned by a machine-learning and/or statistical process, for instance and without limitation as described in further detail below.

Further referring to FIG. 5, in an embodiment, a degree of match between fuzzy sets may be used to classify one or more instances of any one or more of commitment datum 108, novelty datum 112, skill factor datum 116, and/or target datum 118, to as well as external entity interaction datum 158 and/or user attributes 154 stored in user activity database 300. For instance, if commitment datum 108 and/or interface query data structure has a fuzzy set matching certain interface query data structure data values stored in user activity database 300 (e.g., by having a degree of overlap exceeding a threshold), computing device 104 may classify one or more instances of any one or more of commitment datum 108, novelty datum 112, skill factor datum 116, and/or target datum 118 as belonging to user attributes 154 (e.g., aspects of user behavior as demonstrated by user attributes 154 of FIG. 1 and/or user attributes 308 of FIG. 3 relating to user commitment towards achieving target datum 118). Where multiple fuzzy matches are performed, degrees of match for each respective fuzzy set may be computed and aggregated through, for instance, addition, averaging, or the like, to determine an overall degree of match.

Still referring to FIG. 5, in an embodiment, commitment datum 108 and/or novelty datum 112 may be compared to multiple user activity database 300 categorization fuzzy sets. For instance, commitment datum 108 and/or novelty datum 112 may be represented by a fuzzy set that is compared to each of the multiple user activity database 300 categorization fuzzy sets; and a degree of overlap exceeding a threshold between the commitment datum 108 and/or novelty datum fuzzy set and any of the multiple query database 300 categorization fuzzy sets may cause computing device 104 to classify one or more instances of any one or more of commitment datum 108, novelty datum 112, skill factor datum 116, and/or target datum 118 as belonging to one or more corresponding interface query data structures associated with user activity database 300 categorization (e.g., selection from categories in user activity database 300, etc.). For instance, in one embodiment there may be two user activity database 300 categorization fuzzy sets, representing, respectively, user activity database 300 categorization (e.g., into each of user-input datum 304, user attributes 308, external entity interaction datum 312, and/or user activity pattern datum 316). For example, a First user activity database 300 categorization may have a first fuzzy set; a Second user activity database 300 categorization may have a second fuzzy set; and one or more instances of any one or more of commitment datum 108, novelty datum 112, skill factor datum 116, and/or target datum 118, to as well as external entity interaction datum 158 and/or user attributes 154 may each have a corresponding fuzzy set. Computing device 104, for example, may compare one or more instances of any one or more of commitment datum 108, novelty datum 112, skill factor datum 116, and/or target datum 118, to as well as external entity interaction datum 158 and/or user attributes 154 fuzzy sets with fuzzy set data describing each of the categories included in user activity database 300, as described above, and classify one or more instances of any one or more of commitment datum 108, novelty datum 112, skill factor datum 116, and/or target datum 118, to as well as external entity interaction datum 158 and/or user attributes 154 to one or more categories (e.g., user-input datum 304, user attributes 308, external entity interaction datum 312, and/or user activity pattern datum 316). Machine-learning methods as described throughout may, in a non-limiting example, generate coefficients used in fuzzy set equations as described above, such as without limitation x, c, and o of a Gaussian set as described above, as outputs of machine-learning methods. Likewise, any described datum herein may be used indirectly to determine a fuzzy set, as, for example, commitment datum 108 fuzzy set and/or novelty datum 112 fuzzy set may be derived from outputs of one or more machine-learning models that take commitment datum 108 and/or novelty datum 112 directly or indirectly as inputs.

Still referring to FIG. 5, a computing device may use a logic comparison program, such as, but not limited to, a fuzzy logic model to determine a user activity database 300 response. A user activity database 300 response may include, but is not limited to, accessing and/or otherwise communicating with any one or more of user-input datum 304, user attributes 308, external entity interaction datum 312, user activity pattern datum 316, and the like; each such user activity database 300 response may be represented as a value for a linguistic variable representing user activity database 300 response or in other words a fuzzy set as described above that corresponds to a degree of matching between data describing commitment datum 108 and/or novelty datum 112 and one or more categories within user activity database 300 as calculated using any statistical, machine-learning, or other method that may occur to a person skilled in the art upon reviewing the entirety of this disclosure. In some embodiments, determining a user activity database 300 categorization may include using a linear regression model. A linear regression model may include a machine-learning model. A linear regression model may be configured to map data of commitment datum 108 and/or novelty datum 112, to one or more user activity database 300 parameters. A linear regression model may be trained using a machine-learning process. A linear regression model may map statistics such as, but not limited to, quality of commitment datum 108 and/or novelty datum 112. In some embodiments, determining user activity database 300 of commitment datum 108 and/or novelty datum 112 may include using a user activity database 300 classification model. A user activity database 300 classification model may be configured to input collected data and cluster data to a centroid based on, but not limited to, frequency of appearance, linguistic indicators of quality, and the like. Centroids may include scores assigned to them such that quality of commitment datum 108 and/or novelty datum 112 may each be assigned a score. In some embodiments, user activity database 300 classification model may include a K-means clustering model. In some embodiments, user activity database 300 classification model may include a particle swarm optimization model. In some embodiments, determining the user activity database 300 of commitment datum 108 and/or novelty datum 112 may include using a fuzzy inference engine (e.g., to assess the progress of the user and use said data to amend or generate new strategies based on user progress). A fuzzy inference engine may be configured to map one or more instances of any one or more of commitment datum 108, novelty datum 112, skill factor datum 116, and/or target datum 118, to as well as external entity interaction datum 158 and/or user attributes 154data elements using fuzzy logic. In some embodiments, described datum may be arranged by a logic comparison program into query database 300 arrangement. A “user activity database 300 arrangement” as used in this disclosure is any grouping of objects and/or data based on similarity to each other and/or relation to providing customized skill factor datum 224B of FIG. 2B to the user for the user to achieve. This step may be implemented as described above in FIG. 1. Membership function coefficients and/or constants as described above may be tuned according to classification and/or clustering algorithms. For instance, and without limitation, a clustering algorithm may determine a Gaussian or other distribution of questions about a centroid corresponding to a given scoring level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented to assess the progress of the user and use said data to amend or generate new strategies based on user progress according to input and/or output membership functions and/or linguistic variables. For instance, a first linguistic variable may represent a first measurable value pertaining to commitment datum 108 and/or novelty datum 112, such as a degree of matching between data describing user aspirations and strategies based on responses to interface query data structures stored in user activity database 300. Continuing the example, an output linguistic variable may represent, without limitation, a score value. An inference engine may combine rules, such as: “if the demonstrated commitment level of a person or business falls beneath a threshold,” and “the observed performance of the person or business relative to their or its peers is deficient,” the commitment score is ‘deficient’”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “L,” such as max (a, b), probabilistic sum of a and b (a+b−a*b), bounded sum, and/or drastic T-conorm; any T-conorm may be used that satisfies the properties of commutativity: ⊥(a, b)=1 (b, a), monotonicity: ⊥(a, b)≤⊥(c, d) if a≤c and b≤d, associativity: ⊥(a, ⊥(b, c))=⊥(⊥(a, b), c), and identity element of 0. Alternatively, or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

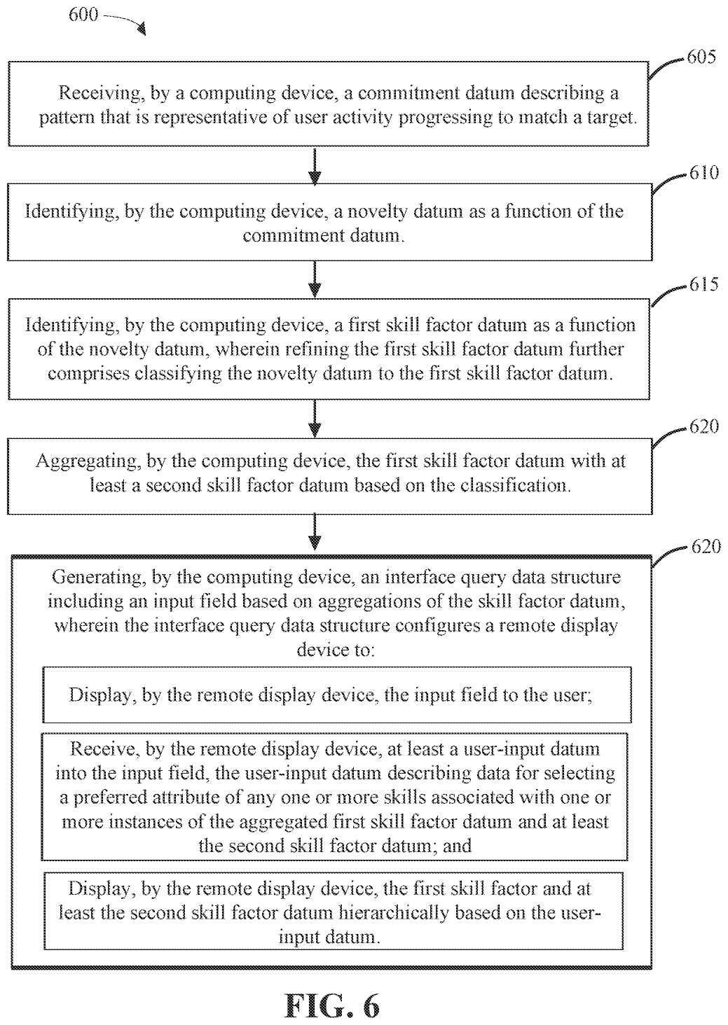

Now referring to FIG. 6, method 600 for. At step 605, method 600 includes receiving, by computing device 104 of FIG. 1, commitment datum 108 describing a pattern that is representative of user activity progressing to match a target. This step may be implemented as described above, without limitation, in FIGS. 1-7.

Still referring to FIG. 6, at step 610, method 600 includes identifying, by computing device 104, novelty datum 112 as a function of the commitment datum. This step may be implemented as described above, without limitation, in FIGS. 1-7.

Still referring to FIG. 6, at step 615, method 600 includes identifying, by computing device 104, a first skill factor datum as a function of the novelty datum, wherein refining the first skill factor datum further comprises classifying novelty datum 112 to the first skill factor datum. This step may be implemented as described above, without limitation, in FIGS. 1-7.

Still referring to FIG. 6, at step 620, method 600 includes generating, by computing device 104, an interface query data structure including an input field based on aggregations of the skill factor datum. The interface query data structure configures display device 132 to display the input field to the user.

In addition, the interface query data structure configures display device 132 to receive at least user-input datum 224A into user input field 148. User-input datum 224A describes data for selecting a preferred attribute of any one or more skills associated with one or more instances of the aggregated first skill factor datum and at least the second skill factor datum. In addition, the interface query data structure configures display device 132 to display the first skill factor and at least the second skill factor datum hierarchically based on user-input datum 224A. This step may be implemented as described above, without limitation, in FIGS. 1-7.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

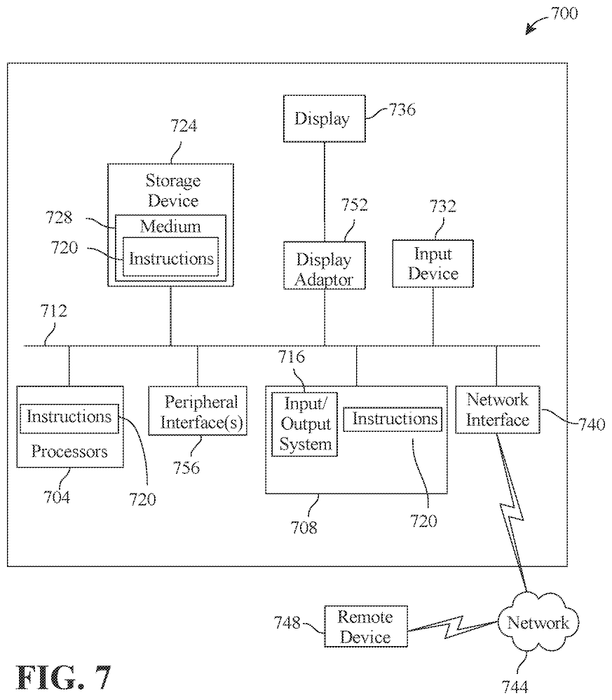

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display device 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Video display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate to provide a multiplicity of feature combinations in associated new embodiments. Furthermore, while the foregoing describes several separate embodiments, what has been described herein is merely illustrative of the application of the principles of the present invention. Additionally, although particular methods herein may be illustrated and/or described as being performed in a specific order, the ordering is highly variable within ordinary skill to achieve methods, apparatus, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for providing a skill factor hierarchy to a user, the apparatus comprising:
at least a processor; and
a memory communicatively connected to the at least a processor, the memory containing instructions configuring the at least a processor to:
receive a commitment datum describing a pattern that is representative of user activity progressing to match a target;
determine a target datum as a function of the commitment datum;
identify a novelty datum as a function of the commitment datum and the target datum, wherein the novelty datum comprises data related to management of resources, and wherein identifying the novelty datum comprises:
classifying the novelty datum into one or more resource categories; and
generating efficiency data as a function of the one or more resource categories;
generate a skill factor datum as a function of the novelty datum;
determine at least an obstacle datum as a function of the target datum and the skill factor datum;
generate a directed process as a function of the at least an obstacle datum, wherein the directed process comprises a set of instructions to improve the efficiency data, and wherein generating the directed process comprises:
generating process training data, wherein the process training data comprises correlations between exemplary obstacle datums, exemplary efficiency data and exemplary directed processes;
iteratively training a process machine-learning model using the process training data as a function of previous iterations; and
generating the directed process using the trained process machine-learning model; and
generate an interface query data structure, wherein the interface query data structure configures a display device to display the efficiency data and the directed process.

2. The apparatus of claim 1, wherein the memory contains instructions further configuring the at least a processor to:
classify the commitment datum to match the target datum between a minimum value and a maximum value of the target datum; and
identify the novelty datum as a function of the classification.

3. The apparatus of claim 1, wherein the memory contains instructions further configuring the at least a processor to generate an extended target datum as a function of the target datum and the skill factor datum.

4. The apparatus of claim 3, wherein the memory contains instructions further configuring the at least a processor to:
determine at least an obstacle datum as a function of the extended target datum; and
generate a directed process as a function of the at least an obstacle datum and the extended target datum.

5. The apparatus of claim 1, wherein the memory contains instructions further configuring the at least a processor to:
generate target training data, wherein the target training data comprises correlations between exemplary commitment datums and exemplary target datums;
train a target machine-learning model using the target training data; and
determine the target datum using the target machine-learning model.

6. The apparatus of claim 1, wherein the memory contains instructions further configuring the at least a processor to:
generate obstacle training data, wherein the target training data comprises correlations between exemplary target datums and exemplary skill factor datums;
train an obstacle machine-learning model using the obstacle training data; and
determine the obstacle datum using the obstacle machine-learning model.

7. The apparatus of claim 6, wherein the memory contains instructions further configuring the at least a processor to iteratively train the obstacle machine-learning model using the obstacle training data as a function of previous iterations of the obstacle machine learning model.

8. The apparatus of claim 1, wherein the memory contains instructions further configuring the at least a processor to:
receive at least one user-input datum;
classify the at least one user-input datum as a function of the target datum; and
display a first skill factor datum and a second skill factor datum of the skill factor datum hierarchically based on the classified at least a user-input datum.

9. The apparatus of claim 1, wherein the memory contains instructions further configuring the at least a processor to:
determine a portion of the novelty datum as a function of a plurality of attributes; and
generate the first skill factor as a function of the portion.

10. The apparatus of claim 9, wherein the memory contains instructions further configuring the at least a processor to receive at least one user-input datum, wherein the at least one user-input datum comprises a preferred attribute of the plurality of attributes.

11. A method for providing a skill factor hierarchy to a user, the method comprising:
receiving, using at least a processor, a commitment datum describing a pattern that is representative of user activity progressing to match a target;
determining, using the at least a processor, a target datum as a function of the commitment datum;
identifying, using the at least a processor, a novelty datum as a function of the commitment datum and the target datum, wherein the novelty datum comprises data related to management of resources, and wherein identifying the novelty datum comprises:
classifying the novelty datum into one or more resource categories; and
generating efficiency data as a function of the one or more resource categories;
generating, using the at least a processor, a skill factor datum as a function of the novelty datum;
determining, using the at least a processor, at least an obstacle datum as a function of the target datum and the skill factor datum;
generating, using the at least a processor, a directed process as a function of the at least an obstacle datum, wherein the directed process comprises a set of instructions to improve the efficiency data, and wherein generating the directed process comprises:
generating process training data, wherein the process training data comprises correlations between exemplary obstacle datums, exemplary efficiency data and exemplary directed processes;
iteratively training a process machine-learning model using the process training data as a function of previous iterations; and
generating the directed process using the trained process machine-learning model; and; and
generating, using the at least a processor, an interface query data structure, wherein the interface query data structure configures a display device to display the efficiency data and the directed process.

12. The method of claim 11, further comprising:
classifying, using the at least a processor, the commitment datum to match the target datum between a minimum value and a maximum value of the target datum; and
identifying, using the at least a processor, the novelty datum as a function of the classification.

13. The method of claim 11, further comprising:
generating, using the at least a processor, an extended target datum as a function of the target datum and the skill factor datum.

14. The method of claim 13, further comprising:
determining, using the at least a processor, at least an obstacle datum as a function of the extended target datum; and
generating, using the at least a processor, a directed process as a function of the at least an obstacle datum and the extended target datum.

15. The method of claim 11, further comprising:
generating, using the at least a processor, target training data, wherein the target training data comprises correlations between exemplary commitment datums and exemplary target datums;
training, using the at least a processor, a target machine-learning model using the target training data; and
determining, using the at least a processor, the target datum using the target machine-learning model.

16. The method of claim 11, further comprising:
generating, using the at least a processor, obstacle training data, wherein the target training data comprises correlations between exemplary target datums and exemplary skill factor datums;
training, using the at least a processor, an obstacle machine-learning model using the obstacle training data; and
determining, using the at least a processor, the obstacle datum using the obstacle machine-learning model.

17. The method of claim 16, further comprising:
iteratively training, using the at least a processor, the obstacle machine-learning model using the obstacle training data as a function of previous iterations of the obstacle machine-learning model.

18. The method of claim 11, further comprising:
receiving, using the at least a processor, at least one user-input datum;
classifying, using the at least a processor, the at least one user-input datum as a function of the target datum; and
displaying, using the at least a processor, a first skill factor datum and a second skill factor datum of the skill factor datum hierarchically based on the classified at least a user-input datum.

19. The method of claim 11, further comprising:
determining, using the at least a processor, a portion of the novelty datum as a function of a plurality of attributes; and
generating, using the at least a processor, the first skill factor as a function of the portion.

20. The method of claim 19, further comprising:
receiving, using the at least a processor, at least one user-input datum, wherein the at least one user-input datum comprises a preferred attribute of the plurality of attributes.
